(19) United States
(12) Patent Application Publication
(10) Pub. No.: US 2026/0057231 A1
(43) Pub. Date: Feb. 26, 2026

(54) SEQUENCE GENERATION TECHNIQUES FOR TRANSFORMERS, HIDDEN MARKOV MODELS, AND MARKOV CHAINS USING ROLLOUT-BASED POLICIES

(71) Applicants: Dimitri Bertsekas, Belmont, MA (US); Yuchao Li, Tempe, AZ (US)

(72) Inventors: Dimitri Bertsekas, Belmont, MA (US); Yuchao Li, Tempe, AZ (US)

(73) Assignee: Arizona Board of Regents on Behalf of Arizona State University, Scottsdale, AZ (US)

(21) Appl. No.: 19/305,268

(22) Filed: Aug. 20, 2025

Related U.S. Application Data
(60) Provisional application No. 63/685,986, filed on Aug. 22, 2024.

(51) Int. Cl. G06N 3/08; G06N 3/0455

(52) U.S. Cl. CPC G06N 3/08; G06N 3/0455

(57) ABSTRACT

An artificial intelligence (AI) model is trained to generate a sequence of tokens, beginning with an initial sequence. Each sequence comprises a fixed number n of elements selected from a vocabulary list accessible to the AI model. A current sequence is iteratively transformed into a next sequence by adding a new element at a designated position and removing an element from another position to maintain the fixed number n of elements. The probability of selecting the new element for the next sequence is determined based solely on the current sequence, without dependence on sequences occurring before it. The sequence of tokens is iteratively output, starting with the initial sequence, using the iterative transformations of the current sequence to form the next sequence.

### CLAIM OF PRIORITY

This application claims the benefit of U.S. Provisional Patent Application No. 63/685,986, filed on 22 Aug. 2024, the entire contents of which are incorporated herein by reference.

### TECHNICAL FIELD

The present disclosure relates generally to machine learning and artificial intelligence models, including techniques for sequence generation in probabilistic and language modeling.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

N-grams are contiguous sequences of N items from a given text or speech, such as characters, words, or other tokens, and are used in natural language processing for tasks such as prediction and translation. Transformers are deep learning architectures that apply self-attention to model relationships between elements in a sequence and are widely used in text generation, translation, and understanding. Hidden Markov Models (HMMs) are statistical models with hidden states that produce observable outputs following the Markov property and are used in applications such as speech recognition and part-of-speech tagging. Markov chains are mathematical models of systems that transition between states with probabilities dependent only on the current state and are used in areas including language modeling, economics, and probabilistic analysis. Alternative techniques such as scheduled sampling and reinforcement learning with human feedback have been explored to mitigate the mismatch. These methods, however, may introduce instability, increase computational cost, or limit scalability.

### SUMMARY

In general, this disclosure relates to systems, methods, and apparatuses for implementing sequence generation in artificial intelligence models, including transformers, Hidden Markov Models (HMMs), and Markov chains, using rollout-based policies. In certain examples, an AI model is trained to generate sequences of a fixed length n from elements in an accessible vocabulary. The generation process maintains the fixed length by adding new elements and removing existing elements according to a defined transformation policy. Probabilities for selecting new elements are determined based on the current sequence without reliance on sequences occurring before the current sequence. Rollout-based techniques from approximate dynamic programming may be used to improve upon a given base policy, such as a probability-maximizing policy, enabling efficient computation of sequences that have high likelihood under the model. The described techniques are applicable to a range of probabilistic modeling contexts, including language modeling, structured prediction, and inference tasks in finite-state systems.

In at least one example, processing circuitry is configured to perform a method that includes training an artificial intelligence (AI) model to generate a sequence of tokens, starting from an initial sequence. In at least one example, the method includes that each sequence in the sequence of tokens comprises a fixed number n of elements selected from a vocabulary list accessible to the AI model. According to certain examples, the method includes iteratively transforming a current sequence among the sequence of tokens into a next sequence by adding a new element at a designated position and removing an element from another position to maintain the fixed number n of elements. In one example, the method includes that a probability of selecting the new element for the next sequence is determined based on the current sequence without dependence on sequences occurring before the current sequence. According to such examples, the method includes iteratively outputting the sequence of tokens, starting with the initial sequence, using the iterative transformations of the current sequence to form the next sequence.

In at least one example, a system includes processing circuitry; non-transitory computer readable media; and instructions that, when executed by the processing circuitry, configure the processing circuitry to perform operations. In such an example, processing circuitry may configure the to: train an artificial intelligence (AI) model to generate a sequence of tokens, starting from an initial sequence. According to certain examples, the system includes wherein each sequence in the sequence of tokens comprises a fixed number n of elements selected from a vocabulary list accessible to the AI model. In one example, the system includes iteratively transforming a current sequence among the sequence of tokens into a next sequence by adding a new element at a designated position and removing an element from another position to maintain the fixed number n of elements. In at least one example, the system includes wherein a probability of selecting the new element for the next sequence is determined based on the current sequence without dependence on sequences occurring before the current sequence. According to such examples, the system includes iteratively outputting the sequence of tokens, starting with the initial sequence, using the iterative transformations of the current sequence to form the next sequence.

In one example, there is computer-readable storage media having instructions that, when executed, configure processing circuitry to train an artificial intelligence (AI) model to generate a sequence of tokens, starting from an initial sequence. According to certain examples, the non-transitory computer-readable storage media includes wherein each sequence in the sequence of tokens comprises a fixed number n of elements selected from a vocabulary list accessible to the AI model. In one example, the non-transitory computer-readable storage media includes iteratively transforming a current sequence among the sequence of tokens into a next sequence by adding a new element at a designated position and removing an element from another position to maintain the fixed number n of elements. In at least one example, the non-transitory computer-readable storage media includes wherein a probability of selecting the new element for the next sequence is determined based on the current sequence without dependence on sequences occurring before the current sequence. According to such examples, the non-transitory computer-readable storage media includes iteratively outputting the sequence of tokens, starting with the initial sequence, using the iterative transformations of the current sequence to form the next sequence.

According to another example, there is a device comprising: means for training an artificial intelligence (AI) model to generate a sequence of tokens, starting from an initial sequence. According to such an example, the device further includes means for generating wherein each sequence in the sequence of tokens comprises a fixed number n of elements selected from a vocabulary list accessible to the AI model. In such an example, the device includes means for iteratively transforming a current sequence among the sequence of tokens into a next sequence by adding a new element at a designated position and removing an element from another position to maintain the fixed number n of elements and means for determining wherein a probability of selecting the new element for the next sequence is determined based on the current sequence without dependence on sequences occurring before the current sequence. In at least one example, the device includes means for iteratively outputting the sequence of tokens, starting with the initial sequence, using the iterative transformations of the current sequence to form the next sequence.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of the disclosure.

FIG. 2 provides a schematic visualization of an n-gram, in accordance with aspects of the disclosure.

FIG. 3 provides an illustration of a state trajectory generated by a policy π, starting at state x at time k on a state axis, in accordance with aspects of the disclosure.

FIG. 4 provides a schematic illustration of rollout with one-step lookahead, in accordance with aspects of the disclosure.

FIG. 5 provides an illustration of multi-step lookahead, [symbol] -step, with [symbol] =2, in accordance with aspects of the disclosure.

FIG. 6 depicts a two-state Markov chain example with state 1 and state 2 connected by transition probabilities as shown next to the transition arcs, in accordance with aspects of the disclosure.

FIG. 7 provides a three-state example, which is similar to the two-state example of FIG. 6, in accordance with aspects of the disclosure.

FIG. 8 illustrates percentage recovery of the optimality loss equation of the greedy policy through the use of rollout and its variants, in accordance with aspects of the disclosure.

FIG. 9A depicts a plot illustrating a problem where increasing the look-ahead length from one step to three steps does not result in significant improvement over rollout π₁, in accordance with aspects of the disclosure.

FIG. 9B depicts a plot illustrating a problem where rollout π₁ produces sequences with high average occurrence probability equation values across states, such that additional look-ahead beyond one step yields little improvement; in this case, rollout π₃ even reduces performance for many states, in accordance with aspects of the disclosure.

FIG. 9C depicts a plot illustrating a problem where substantial improvement in the average occurrence probability equation occurs with rollout π₁ and further improvement occurs with rollout 12, with smaller incremental changes for rollout π₃, in accordance with aspects of the disclosure.

FIG. 9D depicts a plot illustrating a problem in which increasing the look-ahead length from one step to three steps leads to steady and gradual improvement across states, in accordance with aspects of the disclosure.

FIG. 10 illustrates performance recovery for various rollout-based policies, in accordance with aspects of the disclosure.

FIG. 11 depicts occurrence probability of sequences generated by greedy π̅, truncated rollout \tilde{π}^{m}, and rollout \tilde{π}, as shown in a legend, in accordance with aspects of the disclosure.

FIG. 12 is a flow diagram illustrating an example method for training and operating an artificial intelligence (AI) model to generate and iteratively transform sequences of tokens, in accordance with aspects of the disclosure.

Like reference characters denote like elements throughout the text and figures.

### DETAILED DESCRIPTION

In general, this disclosure relates to systems, methods, and apparatuses for implementing sequence generation in artificial intelligence models, including transformers, Hidden Markov Models (HMMs), and Markov chains, using rollout-based policies. In certain examples, an AI model is trained to generate sequences of a fixed length n from elements in an accessible vocabulary. The generation process maintains the fixed length by adding new elements and removing existing elements according to a defined transformation policy. Probabilities for selecting new elements are determined based on the current sequence without reliance on sequences occurring before the current sequence. Rollout-based techniques from approximate dynamic programming may be used to improve upon a given base policy, such as a probability-maximizing policy, enabling efficient computation of sequences that have high likelihood under the model. The described techniques are applicable to a range of probabilistic modeling contexts, including language modeling, structured prediction, and inference tasks in finite-state systems.

INTRODUCTION: Generative pre-trained transformers (GPT) have sparked a lot of enthusiasm for innovative applications in many problem domains, aided by powerful openly available software, and easy-to-use natural language interfaces. At the same time, transformers have been established as a flexible and powerful model, which generalizes in important ways earlier forms of neural networks by using the attention mechanism and more complex nonlinearities (see the recent textbook by Bishop and Bishop [BiB24], Chapter 12, for a description of the transformer architecture, with earlier references to the literature).

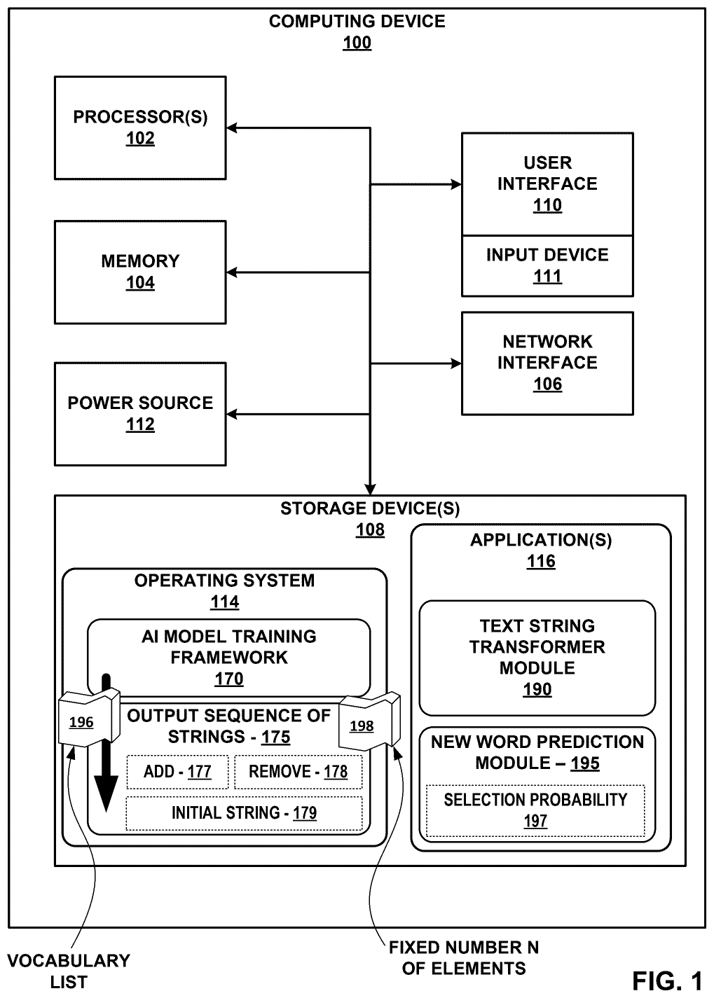

FIG. 1 is a block diagram illustrating further details of one example of computing device 100, in accordance with aspects of this disclosure. FIG. 1 illustrates only one particular example of computing device 100. Many other example embodiments of computing device 100 may be used in other instances.

As shown in the specific example of FIG. 1, computing device 100 may include processor(s) 102, memory 104, network interface 106, storage device(s) 108, user interface 110, input device 111, and power source 112. Computing device 100 may also include operating system 114. Computing device 100, in one example, may further include application(s) 116, including text string transformer module 190 and new word prediction module 195.

Operating system 114 may execute various functions of AI model training framework 170. AI model training framework 170 may be utilized to generate an output sequence of strings 175 that includes add 177, remove 178, and initial string 179. Initial string 179 represents a starting sequence of elements from vocabulary list 196 having fixed number N of elements 198. Add 177 designates a new element to be inserted at a position within the current sequence, and remove 178 designates an element to be removed from another position in the current sequence to maintain fixed number N of elements 198. Output sequence of strings 175 may receive vocabulary list 196 and fixed number N of elements 198 as input. AI model training framework 170 may iteratively apply add 177 and remove 178 to transform the current sequence into a next sequence and generate new words for output sequence of strings 175.

New word prediction module 195 may include selection probability 197 that may be utilized to determine which new words are added to output sequence of strings 175. Text string transformer module 190 may transform text strings during processing by computing device 100.

In some examples, processing circuitry including processor(s) 102 implements functionality and/or process instructions for execution within computing device 100. For example, processor(s) 102 may be capable of processing instructions stored in memory 104 and/or instructions stored on storage device(s) 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by processor(s) 102. Memory 104, in one example, may be used by software or application(s) 116 to temporarily store data and/or instructions during program execution.

Storage device(s) 108, in some examples, may also include one or more computer-readable storage media. Storage device(s) 108 may be configured to store larger amounts of information than memory 104. Storage device(s) 108 may further be configured for long-term storage of information. In some examples, storage device(s) 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

Computing device 100 may also include user interface 110. User interface 110 may include input device 111. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone, or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Operating system 114 may be stored in storage device(s) 108 and may control the operation of components of computing device 100. For example, operating system 114 may facilitate the interaction of application(s) 116 with hardware components of computing device 100.

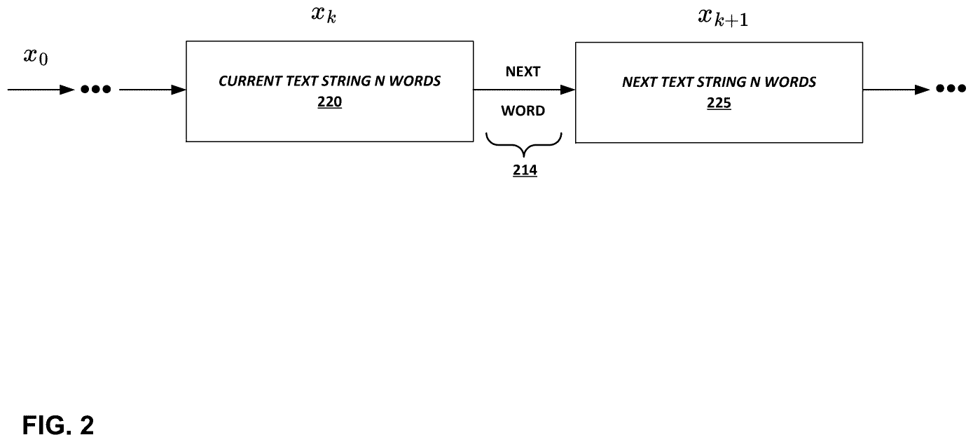

FIG. 2 provides a schematic visualization of an n-gram, in accordance with aspects of the disclosure. FIG. 2 illustrates only one particular example of such generation, and many other example embodiments may be used in other instances.

In the example of FIG. 2, current text string n words 220 represents a sequence of n words currently under evaluation by AI model training framework 170. Current text string n words 220 may be generated from an initial sequence x₀, such as initial string 179 described in connection with FIG. 1, or from any intermediate sequence xₖ during iterative generation. Current text string n words 220 may be provided as input to a next word 214 process, which represents the determination of a next word to append to or otherwise incorporate into the current sequence. Next word 214 may be selected from a vocabulary list, such as vocabulary list 196 described in connection with FIG. 1, based on one or more predictive or probabilistic selection algorithms executed by AI model training framework 170.

Next word 214 may be applied to current text string n words 220 to form next text string n words 225. Next text string n words 225 represents a new sequence of n words that includes the newly generated next word 214 while maintaining the specified sequence length n, for example, by adding the next word 214 to the end of the sequence and removing an oldest word from the beginning of the sequence. In some examples, next text string n words 225 may serve as the current text string n words 220 for a subsequent iteration, enabling AI model training framework 170 to produce an output sequence of strings, such as output sequence of strings 175, by repeatedly executing the next word 214 determination and text string update process shown in FIG. 2.

A transformer is described in terms of the classical n-gram model that generates a sequence {x₁, . . . , x_{N}} of text strings, starting from some initial string x₀. Each string xₖ consists of a sequence of n words, chosen from a given list (e.g., the vocabulary of the n-gram). The transformation from xₖ to xₖ+1 follows the update process described above and shown in FIG. 2, ensuring the sequence length n is maintained.

Here n and N are fixed positive integers. Given a text string xₖ, the n-gram provides probabilities p(xₖ₊₁|xₖ) for the next text string xₖ₊₁. These probabilities also define the probabilities of the possible next words, since xₖ₊₁ is determined by the next word 214 that is added to the front of xₖ. Assume that the probabilities p(xₖ₊₁|xₖ) depend only on xₖ. Thus, the probabilities may be viewed as the transition probabilities of a stationary Markov chain, having a state space that is the set of all n word sequences xₖ.

Bearing this context in mind, also refer to xₖ as the state (of the underlying Markov chain). The stationarity assumption simplifies notation, but is not essential to the methodology, as described below. The probabilities p(xₖ₊₁|xₖ) can provide guidance for generating state sequences with some specific purpose in mind. To this end, a transformer may use a (next word 214) selection policy, i.e., a (possibly time-dependent) function μₖ, which selects the text string that follows xₖ according to the following term: xₖ₊₁=μₖ(xₖ). Consider selection policies that give preference to high probability future words. Two frequently considered policies are:

Greedy selection: Here, given xₖ, the next state xₖ₊₁ is selected to be the one that maximizes the term p(xₖ₊₁|xₖ), according to the following term:

$${μ}_{k} ( {x}_{k} ) ∈ arg {max}_{{x}_{k + 1}} p ( {x}_{k + 1} \vert {x}_{k} ) .$$

To generate a sequence {x₁, . . . , x_{N}} of N states, this selection policy utilizes computation that is proportional to N and to the size of the n-gram's vocabulary (the number of all possible next words).

Most likely sequence selection: Consider all the possible sequences {x₁, . . . , x_{N}} that can be generated starting with x₀, and select the sequence that is most likely, i.e., has maximal probability of occurrence. For clarity, a most-likely sequence refers to a sequence {x₁, . . . , x_N} that maximizes the joint probability under the model, given a starting state x₀. This selection policy consumes computation that grows linearly with N and exponentially with the size of the n-gram's vocabulary. The next word 214 selection policy affects substantially the behavior of the n-gram, depending on the practical context at hand. In particular, contrary to the greedy selection method, the most likely sequence selection method takes into account future selections, beyond the next word 214 choice.

However, computing the most likely sequence is an intractable problem, as noted above. The most likely sequence may only be obtained by generating the tree of the possible sequences {x₁, . . . , x_{N}} given the initial state x₀, and then using a shortest path-type method to compute the most likely sequence. For example, forward or backward dynamic programming (DP) can be used as described in greater detail below.

Consider an intermediate next word 214 selection method, the rollout selection policy, which is an approximate DP method, well known for its simplicity and good performance record, owing to its close connection to the fundamental DP algorithm of policy iteration. The rollout approach was first applied to deterministic combinatorial optimization problems, and it has been extensively investigated and tested in the context of many types of DP problems, both deterministic and stochastic. The rollout approach produces highly likely (near optimal) sequences, with computation that is larger than the greedy selection method by a factor that is proportional to N and to the size of the n-gram's vocabulary. This represents a substantial increase over the greedy selection method, but is still far lower than the exponential computation of the most likely selection method. Note that variants that aim to further reduce the computational requirements of the rollout selection policy are possible, including simplified and truncated versions, which will be discussed later.

The good performance of the rollout algorithm and its variants owes its success and reliability to its connection with the approximation in value space approach of reinforcement learning. In this context, the rollout algorithm and its approximate or enhanced variants are interpreted as a step of Newton's method for solving the Bellman equation underlying the corresponding DP problem. Consider the greedy, most likely, and rollout selection policies within a more general context where the transformer is replaced by an arbitrary stationary finite-state Markov chain. Discussed below are variants of the rollout approach, including simplified, truncated, multistep, and multi-iteration rollout. The discussion below analytically compares the three types of policies followed by results of the computational experimentation.

In some implementations, training may employ a rollout procedure. A rollout can include generating a partial sequence using the predictive model and then completing the remainder of the sequence using the same or a related model. The completed sequence may then be evaluated relative to reference data to provide a signal that can be used for updating model parameters. Rollout approaches may allow the model to learn from intermediate decision points rather than relying solely on fully generated sequences. In some implementations, training with rollout may provide additional flexibility, such as allowing intermediate corrections or updates during sequence generation. This can enable the model to adaptively refine its outputs based on observed outcomes, while still maintaining consistency with long-range dependencies. Rollout training may be combined with other procedures to further improve convergence and stability.

In further implementations, a lookahead procedure may be used during training or inference. A lookahead procedure can include evaluating one or more candidate tokens or subsequences before selecting a next token to commit to the sequence. By examining potential continuations in advance, the model may select outputs that are more consistent with long-range dependencies or overall sequence structure. Lookahead operations may be applied at different depths, such as one token ahead or multiple tokens ahead, and may be combined with or independent from rollout techniques. In some cases, lookahead may be selectively enabled for portions of a sequence where long-range coherence is most critical, thereby balancing computational cost with improved accuracy.

### The Greedy, Most Likely, and Rollout Selection Methods For a Stationary Markov Chain:

Consider a greedy, most likely, and rollout selection policies within a general Markov chain framework. In particular, consider a stationary Markov chain with a finite state space X. The symbols x and y are used for states, and the chain's transition probabilities are denoted by p(y|x). Assume that given a state x, the probabilities p(y|x) are either known or can be generated on-line by purposefully configured software, such as a transformer. Assume stationarity of the Markov chain in part to alleviate an overburdened notation, and also because n-gram and transformer models are typically assumed to be stationary.

However, the rollout methodology and the manner in which it is used does not depend at all on stationarity of the transition probabilities, or infinite horizon properties of Markov chains, such as ergodic classes, transient states, etc. In fact, they also do not depend on the stationarity of the state space either. Only the Markov property is used in the following discussion, i.e., the probability of the next state depends on the immediately preceding state, and not on earlier states. A selection policy π is a sequence of functions {μ₀, . . . , μ_{N-1}}, which given the current state xₖ, determines the next state xₖ+1 as set forth according to the following term:

$${x}_{k + 1} = {μ}_{k} ( {x}_{k} ) .$$

Note that for a given x, the state evolution is deterministic. Thus, for a given π and x₀, the generated state sequence {x₁, . . . , x_{N}} is fully determined. Moreover, the choice of π is arbitrary, although of primary interest are policies π that give preference to high probability next states. Given a policy π={μ₀, . . . , μ_{N-1}} and a starting state x at time k, the state at future times m>k is denoted by y_{m,k}(x, π) according to the following term: y_{m,k}(x, π)=state at time m>k starting at state x and using T.

The state trajectory generated by a policy π, starting at state x at time k, is the sequence, according to the following term:

$${y}_{k + 1 , k} ( x , π ) , … , {y}_{N , k} ( x , π ) ,$$

and the probability of its occurrence in the given Markov chain is defined according to Equation 1 set forth below, as follows:

$${P}_{k} ( x , π ) = p ( {y}_{k + 1 , k} ( x , π ) \vert x ) \cdot {\prod }_{i = k + 1}^{N - 1} p ( {y}_{i + 1 , k} ( x , π ) \vert {y}_{i , k} ( x , π ) ) ,$$

according to the multiplication rule for conditional probabilities.

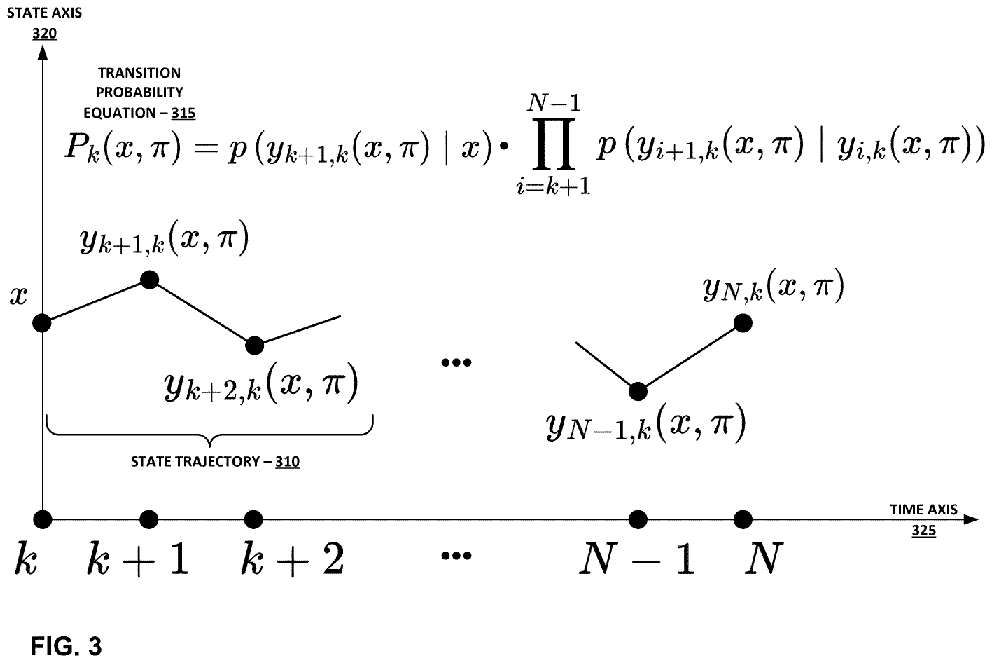

FIG. 3 provides an illustration of state trajectory 310 generated by a policy, starting at state x at time k on state axis 320, in accordance with aspects of the disclosure. For instance, the probability of its occurrence, transition probability equation 315, Pₖ(x, π), is the product of the transition probabilities along the N-k steps of state trajectory 310 extending along time axis 325. State axis 320 extends vertically and time axis 325 extends horizontally to provide the respective axes for state trajectory 310, which includes labeled states y_{k+1,k}(x, π), y_{k+2,k}(x, π), y_{N-1,k}(x, π), and y_{N,k}(x, π) as shown in transition probability equation 315 (refer to Equation 11 below).

The process of generating a sequence may be represented as a finite-state Markov chain. A state can correspond to a prefix of tokens that has been generated so far, and an action can correspond to the selection of a next token from a vocabulary. Transition probabilities can be defined by conditional distributions over tokens given a prefix, and the process may advance by repeatedly applying these transitions until a terminal condition such as an end-of-sequence token is reached. A reward signal, such as log-probability of the full sequence or a task-specific utility, can be associated with terminal states or with intermediate transitions. Within this formulation, selection methods such as greedy choice, most likely sequence determination, and rollout-based evaluation can be interpreted as policies for navigating the Markov chain, each policy differing in how future returns are estimated or approximated during the decision process.

Although transformer models and other sequence generators are not literally constrained to finite state spaces, the Markov chain framework provides a convenient abstraction for analysis. By mapping prefixes and transitions into states and actions, the framework enables comparison among different sequence selection strategies under a unified probabilistic model. This abstraction can simplify reasoning about expected returns, convergence behavior, and trade-offs between computational cost and prediction accuracy without limiting the applicability to a specific architecture.

In particular, when the sequence generator is a transformer model, the Markov chain states can be identified with the hidden state representations produced at each time step, while the transition probabilities correspond to the conditional distributions defined by the model's output logits over the vocabulary. The rollout policies therefore operate by applying the one-step or multi-step look-ahead selection to these logits or their associated softmax probabilities, enabling the same performance-improvement properties as in the finite-state formulation. This connection allows rollout-based selection strategies to be implemented directly on transformer models, without requiring an explicit enumeration of finite states, thereby extending the applicability of the framework to modern neural architectures.

### Optimal/Most Likely Selection Policy:

The most likely selection policy, denoted by:

$${π}^{*} = \{ {μ}_{0}^{*} , … , {μ}_{N - 1}^{*} \} ,$$

maximizes over all policies π the probabilities Pₖ(x, π) for every initial state x and time k. The corresponding probabilities of π*, starting at state x at time k, are denoted by

$${P}_{k}^{*} ( x )$$

according to the term:

$${P}_{k}^{*} ( x ) = {P}_{k} ( x , {π}^{*} ) = {max}_{π} {P}_{k} ( x , π ) .$$

One way to compute the policy π* and its probabilities

$${P}_{k}^{*} ( x )$$

is to use the following DP-like algorithm, which operates in two stages:

First, compute the probabilities

$${P}_{k}^{*} ( x )$$

backwards, for all x, according to Equation 2 set forth below, as follows:

$${P}_{k}^{*} ( x ) = {max}_{y} p ( y \vert x ) {P}_{k + 1}^{*} ( y ) , k = N - 1 , … , 0 ,$$

starting with the term:

$${P}_{N}^{*} ( x ) ≡ 1 .$$

Then generate sequentially the selections

$${x}_{1}^{*} , … , {x}_{N}^{*}$$

of π* according to Equation 3 set forth below, as follows:

$${x}_{k + 1}^{*} = {μ}_{k}^{*} ( {x}_{k}^{*} ) ∈ arg {max}_{y} p ( y \vert {x}_{k}^{*} ) {P}_{k + 1}^{*} ( y ) ,$$

going forwards starting with

$${x}_{0}^{*} = {x}_{0} .$$

The recursive formulation ensures that the selected policy maximizes the joint probability of the sequence among all candidate policies. By computing state-dependent maximum probabilities through backward recursion and then selecting corresponding actions in a forward rollout, the resulting policy achieves global optimality with respect to likelihood. This approach guarantees that no alternative action sequence can yield a higher probability of occurrence.

In some implementations, exact computation of the globally optimal sequence policy may be computationally expensive. Accordingly, approximation strategies may be employed, such as pruning low-probability branches, beam search, or stochastic sampling methods, which trade off guaranteed optimality for improved computational efficiency. These approaches allow the framework to be applied in large-scale or real-time scenarios, while still capturing the essential probabilistic structure of the sequence generation problem.

This algorithm is equivalent to the usual DP algorithm for multistage additive costs, after taking logarithms of the multiplicative expressions in transition probability equation 315 that define the probabilities Pₖ(x, π).

Note that the problem of finding the most likely sequence generated by a Markov chain arises in many important contexts, and its solution by DP-like methods may be applied as a solution. A major example is inference of the sequence of states of a Hidden Markov Model (HMM), given an associated sequence of observed data. This is the problem where Viterbi decoding and related algorithms are used, providing a useful role in several diverse fields, such as speech recognition, computational linguistics and language translation, coding and error correction, bioinformatics, and others. Compared to these fields, the transformer/n-gram contexts tend to involve Markov chains with an intractably larger state space.

Moreover, while approximations are commonly employed in applications of the Viterbi algorithm to these fields, the rollout approach for approximating most likely sequences has not been considered.

Greedy Policy: In contrast to the rollout approach, a greedy policy operates by selecting, at each step, the token with the highest conditional probability given the current prefix. This procedure can yield a single candidate sequence by deterministically following local maxima of the conditional distribution. By comparison, a most likely sequence policy seeks the sequence with the highest overall probability across all possible completions, which generally requires consideration of long-range dependencies beyond local maxima. The greedy policy can therefore be interpreted as a local approximation to the globally most likely sequence, with differences between the two approaches arising when an early local choice prevents access to a higher probability continuation later in the sequence.

At any given state xₖ, the greedy policy produces the next state by maximization of the corresponding transition probability over all y according to the term:

$${max}_{y} p ( y \vert {x}_{k} ) .$$

Assume that ties in the above maximization are broken according to some prespecified deterministic rule. For example, if the states are labeled by distinct integers, one possibility is to specify the greedy selection at xₖ as the state y with minimal label, among those that attain the maximum above. Note that the greedy policy is not only deterministic, but it is also stationary (its selections depend only on the current state and not on the time k). Consequently, use the notation π̅={μ̅, . . . , μ̅} for the greedy policy, according to Equation 4 set forth below, as follows:

$$\overline{μ} ( {x}_{k} ) ∈ arg {max}_{y} p ( y \vert {x}_{k} ) , and \overline{μ} ( {x}_{k} )$$

is uniquely defined according to deterministic convention for breaking ties in the maximization above.

The corresponding probabilities Pₖ(xₖ, π̅) are given by the DP-like algorithm according to Equation 5, set forth below, as follows:

$${P}_{k} ( x , \overline{π} ) = p ( \overline{μ} ( x ) \vert x ) {P}_{k + 1} ( \overline{μ} ( x ) , \overline{π} ) , k = N - 1 , … , 0 ,$$

starting with the term: P_{N}(x, π)≡1.

Equivalently, one may compute Pₖ(x, π) by using a forward multiplication of the transition probabilities along state trajectory 310 generated by the greedy policy, starting from state x on state axis 320, passing through labeled states y_{k+1,k}(x, π), y_{k+2,k}(x, π), y_{N-1,k}(x, π), and y_{N,k}(x, π) along time axis 325 in accordance with transition probability equation 315 (see Equation 1, above). Greedy search algorithms are used widely in discrete optimization problems, with their principal limitation being that they choose the locally optimal next state without considering the impact of this choice on future state selections. Conversely, the rollout approach mitigates this limitation with a mechanism for looking into the future and balancing the desire for a high-probability next state, represented on state trajectory 310, with the potential undesirability of low-probability future states along time axis 325.

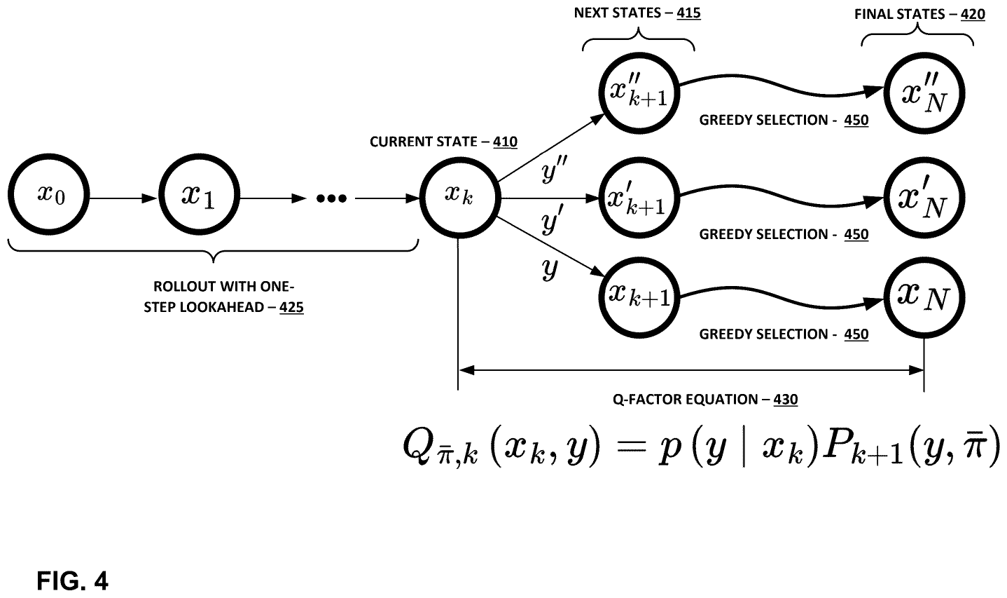

FIG. 4 provides a schematic illustration of rollout with one-step lookahead 425 in accordance with aspects of the disclosure. For instance, at current state 410, xₖ, Q-factor equation 430 is computed according to the term:

$${Q}_{\overline{π} , k} ( {x}_{k} , y ) = p ( y \vert {x}_{k} ) {P}_{k + 1} ( y , \overline{π} )$$

by running greedy selection 450 from all possible next states 415. Then, final states 420 are reached through greedy selection 450 for each possible next state 415, xₖ₊₁. The next state from current state 410 is selected as the state that yields the maximal Q-factor.

Rollout Policy: At any given current state 410, xₖ, rollout with one-step lookahead 425 produces \tilde{μ}k(xₖ), by maximizing p(y|xₖ)Pₖ₊₁(y, π) over all y, assuming that the subsequent states will be chosen using greedy selection 450, according to Equation 6 set forth below, as follows:

$${\tilde{μ}}_{k} ( {x}_{k} ) ∈ arg {max}_{y} p ( y \vert {x}_{k} ) {P}_{k + 1} ( y , \overline{π} ) .$$

Consequently, the notation \tilde{π}={\tilde{μ}₀, . . . , \tilde{μ}_{N-1}} is used for the rollout policy, optimizing the selection of the first state y, assuming that the subsequent states will be chosen using the greedy policy.

By comparing the maximization with the one for the most likely selection policy (refer to Equation 3), it chooses the next state similarly, except that Pₖ₊₁*(y), which is computationally difficult to compute, is replaced by the more easily computable probability Pₖ₊₁(y, π).

In particular, this probability is computed for every y by running greedy selection 450 forward starting from each next state 415 and multiplying the corresponding transition probabilities along the generated state trajectory until reaching final states 420, as shown in FIG. 4. This computation is polynomial in complexity and is roughly larger by a factor of q. N over greedy selection 450, where q is the number of Q-factors computed at each time step. However, there are ways to reduce this computation, including the use of parallel computation and other possibilities, which are discussed below. The expression p(y|xₖ)Pₖ₊₁(y, π) that is maximized over y in Equation 6 is the Q-factor of the pair (xₖ, y), corresponding to the base policy π̅ in the terminology of the rollout approach, and is given by Q-factor equation 430, according to Equation 7 set forth below, as follows:

$${Q}_{\overline{π} , k} ( {x}_{k} , y ) = p ( y \vert {x}_{k} ) {P}_{k + 1} ( y , \overline{π} ) .$$

The Q-factor terminology comes from schemes of approximation in value space, which underlie some of the most visible successes of reinforcement learning. In this context, at current state 410, xₖ, choose the action y that yields the maximal Q-factor.

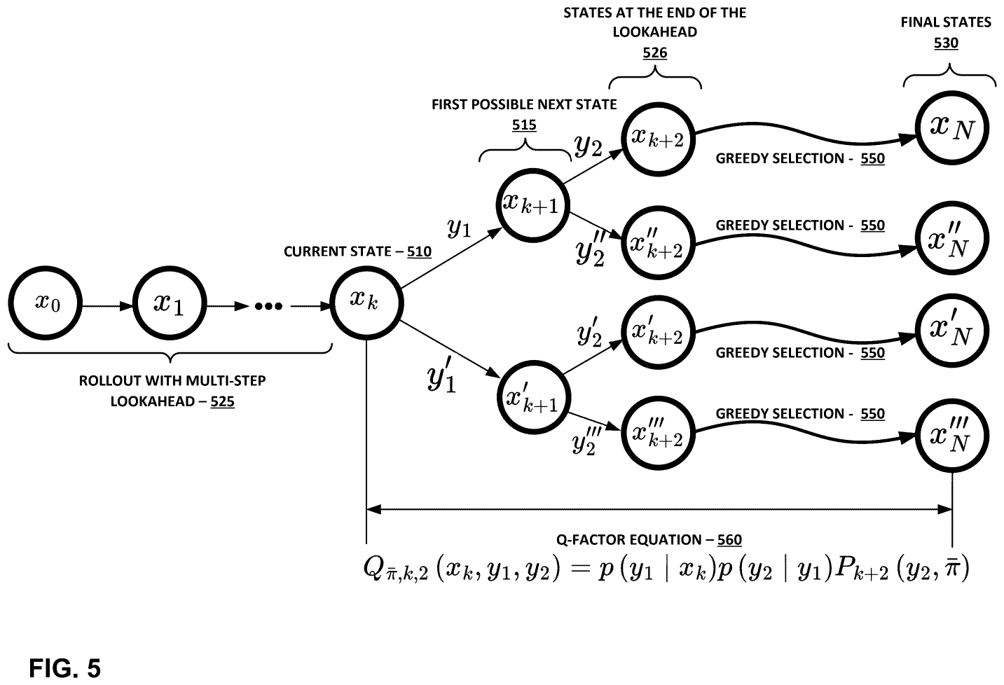

FIG. 5 provides an illustration of multi-step lookahead 525, [symbol] -step, with [symbol] =2, in accordance with aspects of the disclosure. For instance, at current state 510, xₖ, all pairs {y₁, y₂}, are considered to maximize the [symbol] -step Q-factor equation 560 according to the term:

$${Q}_{\overline{π} , k , ℓ} ( {x}_{k} , {y}_{1} , {y}_{2} ) = p ( {y}_{1} \vert {x}_{k} ) p ( {y}_{2} \vert {y}_{1} ) {P}_{k + ℓ} ( {y}_{2} , \overline{π} ) ,$$

as shown in Equation 8. FIG. 5 illustrates the case [symbol] =2, if {\tilde{y}₁, \tilde{y}₂} is the maximizing sequence, select \tilde{y}₁ and discard \tilde{y}₂.

Current state 510 transitions via y₁ to first possible next state 515, xₖ₊₁, which transitions via y₂ to states at the end of lookahead 526, xₖ₊₂, and via y″₂ to states at the end of lookahead 526, x″ₖ₊₂. Current state 510 transitions via y′₁ to first possible next state 515, x′k₊₁, which transitions via y′₂ to states at the end of lookahead 526, x′ₖ₊₂, and via y″₂ to states at the end of lookahead 526, x″ₖ₊₂. Each of states at the end of lookahead 526 proceeds through greedy selection 550 to final states 530, including x_{N},

$${x}_{N}^{″} , {x}_{N}^{′} , and {x}_{N}^{′′′} .$$

If {y₁, y₂} is the maximizing sequence, y₁ is selected and y₂ is discarded.

Rollout Policy with [symbol] -Step Look-ahead: Rollout with multi-step lookahead 525 can include [symbol] -step multi-step lookahead 525 ( [symbol] >1), whereby given xₖ, the process maximizes over all sequences {y₁, y₂, . . . , y [symbol] }, up to [symbol] steps ahead using the & step Q-factor equation 560 according to equation 8, as follows:

$${Q}_{\overline{π} , k , ℓ} ( {x}_{k} , {y}_{1} , … , {y}_{ℓ} ) = p ( {y}_{1} \vert {x}_{k} ) p ( {y}_{2} \vert {y}_{1} ) … p ( {y}_{ℓ} \vert {x}_{ℓ - 1} ) {P}_{k + ℓ} ( {y}_{ℓ} , \overline{π} ) ,$$

and if {\tilde{y}₁, \tilde{y}₂, . . . , \tilde{y} [symbol] } is the maximizing sequence, select § 1 at xₖ, and discard the remaining states \tilde{y}2, . . . , \tilde{y} [symbol] ; refer again to FIG. 5.

If [symbol] >N−k, then [symbol] is reduced to N−k, to take into account end-of-horizon effects. Performance of f-step lookahead 525 can improve with increasing [symbol] ; however, examples exist where performance does not improve with increasing [symbol] . Computational overhead of [symbol] -step lookahead 525 increases with [symbol] , and for [symbol] =N, the rollout policy coincides with the most likely selection policy.

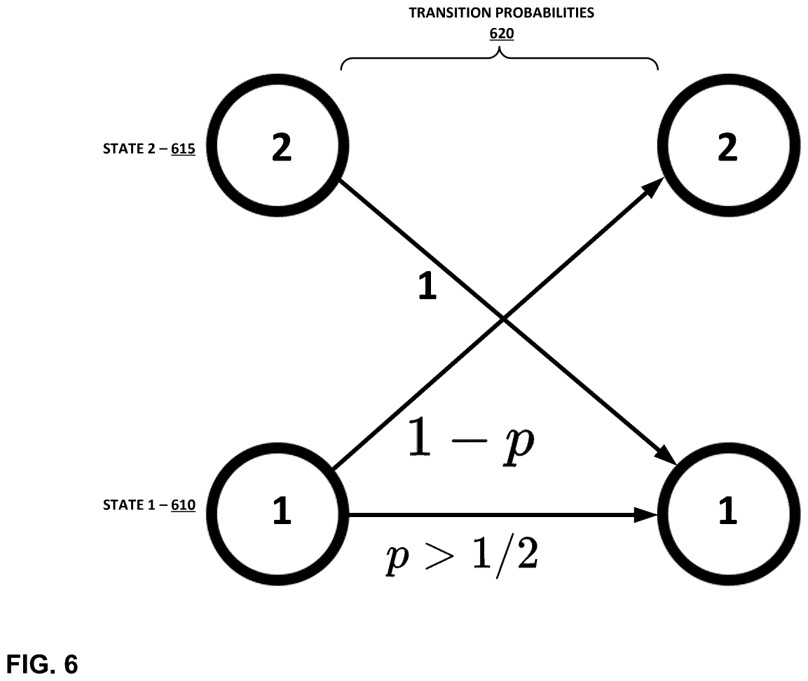

FIG. 6 depicts a two-state Markov chain example with state 1 610 and state 2 615 connected by transition probabilities 620 as shown next to the transition arcs, in accordance with aspects of the disclosure. Transition probabilities 620 include probability p>1/2 from state 1 610 to state 1 610, probability 1−p from state 1 610 to state 2 615, and probability 1 from state 2 615 to state 1 610. A transition from state 2 615 to state 2 615 is not present in this example. Transition not shown in the diagram has probability 0. In this example, assume that x₀=1, p>1/2, and N is even.

Illustrative Examples: Consider the preceding selection policies with examples. FIG. 6 provides a two-state example, where the starting state is state 1 610. In this example, consider each of the statements (a) through (d), set forth as follows:

Statement (a): The greedy policy π̅ generates the sequence {1,1, . . . , 1} and the corresponding probability P_{N}(1, π̅) is equal to p^{N}.

Statement (b): The most likely selection policy π* operates as follows: If p²<1−p, i.e., 0.5<p<0.618, it generates the sequence {1,2,1,2, . . . , 1,2} and the corresponding probability

$${P}_{N}^{*} ( 1 ) is {( 1 - p )}^{N / 2}$$

(so it is larger than the one of the greedy policy). If p²>1−p, i.e., 0.618<p, it generates the sequence {1,1, . . . , 1} and the corresponding probability

$${P}_{N}^{*} ( 1 )$$

is p^{N} (the same as the greedy policy). For p≈1/2, having the term:

$${P}_{N} ( 1 , \overline{π} ) \approx {{P}_{N}^{*} ( 1 )}^{2} ,$$

the greedy policy is far from optimal.

Statement (c): The rollout policy generates the same sequence as the most likely selection policy. In particular, at state 1 610 it computes the two Q-factors, corresponding to the next states state 1 610 and state 2 615 (refer to Equation 7), according to the terms:

$${Q}_{\overline{π} , N} ( 1 , 1 ) = {p}^{N} , and {Q}_{\overline{π} , N} ( 1 , 2 ) = ( 1 - p ) {p}^{N - 2} ,$$

and selects the action that attains the maximum of the two. This yields the same result as the optimal/most likely selection policy.

The preceding example is consistent with general theoretical and empirical results regarding the rollout approach. Specifically, its performance is substantially better than the one of its corresponding base policy, and is close to the optimal.

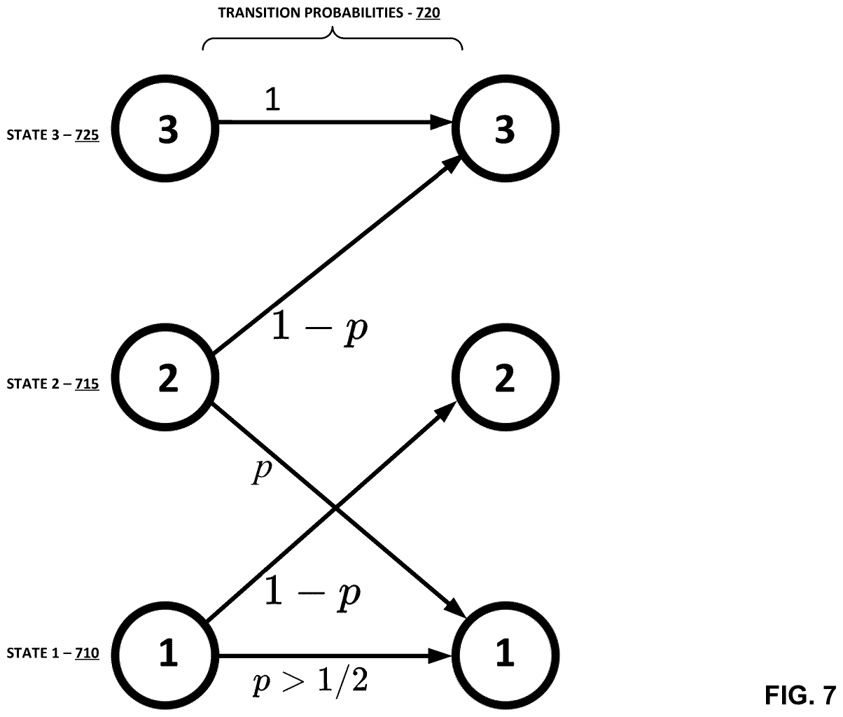

FIG. 7 depicts state 1 710, state 2 715, and state 3 725 connected by transition probabilities 720 as shown next to the straight process flow arrows between states, with transitions not shown in the figure having probability 0. Assume that x₀=1 and that

$$p > \frac{1}{2} .$$

FIG. 7 provides a three-state example, which is similar to the two-state example of FIG. 6, in accordance with aspects of the disclosure. FIG. 7 illustrates the mechanism by which two-step look-ahead rollout can work better than the one-step look-ahead version.

For instance, consider each of the following statements in the context of the example of FIG. 7, as follows:

Statement (a): The greedy policy π generates the sequence {1, 1, . . . , 1} and the corresponding probability P_{N}(1, π̅) is equal to p^{N}.

Statement (b): The most likely selection policy π* generates the sequence {1,2,3,3, . . . , 3} and the corresponding probability is

$${P}_{N}^{*} ( 1 ) = {( 1 - p )}^{2} ,$$

which is much larger than the one of the greedy policy.

Statement (c): The rollout policy with one-step look-ahead at state 1 710 computes the two Q-factors corresponding to the next states state 1 710 and state 2 715, according to the terms:

$${Q}_{\overline{π} , N} ( 1 , 1 ) = {p}^{N} , {Q}_{\overline{π} , N} ( 1 , 2 ) = ( 1 - p ) {p}^{N - 1} .$$

It thus selects state 1 710 as the next state, and the process is repeated. The resulting sequence is {1,1, . . . , 1}, the same as generated by the greedy policy.

Statement (d): The rollout policy with two-step look-ahead at state 1 710 computes and compares the two-step ahead Q-factors (refer to Equation 9). Consider having the terms:

$${Q}_{\overline{π} , N} ( 1 , 1 , 1 ) = {p}^{N} ,$$

$${Q}_{\overline{π} , N} ( 1 , 1 , 2 ) = ( 1 - p ) {p}^{N - 1} ,$$

$${Q}_{\overline{π} , N} ( 1 , 2 , 1 ) = ( 1 - p ) {p}^{N - 1} ,$$

$${Q}_{\overline{π} , N} ( 1 , 2 , 3 ) = {( 1 - p )}^{2} ,$$

so based on the maximizing Q-factor Q_{π̅,N}(1,2,3), processing according to the policy selects state 2 715. From state 2 715, processing according to the policy selects state 3 725, so the generated sequence is {1,2,3,3, . . . , 3}, t the same as obtained by the most likely selection policy.

### Variants of the Rollout Policy:

There are several variants of the rollout policy, each aimed at either reducing the computational requirements or improving the performance of the rollout approach. These and other additional possibilities are discussed below in the context of computational experiments.

Simplified Rollout: A difficulty that arises in the application of rollout is the potentially very large number of Q-factors that need to be calculated at each time step at the current state, such as state 1 710, state 2 715, or state 3 725. This number is equal to the number of states y for which p(y|x)>0, as defined by the transition probabilities 720. In practice, the computation of Q-factors can be restricted to a subset of the most probable next states, as determined by transition probabilities 720, which is a common expedient in the rollout approach called simplified rollout. Conditions may exist under which the performance of the simplified algorithm is not compromised by this simplification.

For example, often many of the transition probabilities 720, p(y|x), are very close to zero and can be safely ignored. Simplified rollout resembles in some respects the method of beam search for exploring the Markov chain of a large language model. However, beam search is different in that it prunes the Markov chain starting from an initial state, such as state 1 710, by discarding the most unlikely next states sequentially over multiple steps. By contrast, simplified rollout reduces the number of Q-factors calculated for the greedy policy at the current step only, without reducing the calculations in subsequent steps.

Truncated Rollout: Another common way to reduce computation is to truncate the trajectories generated from the next states y, such as state 1 710, state 2 715, or state 3 725, by the greedy policy, up to m steps, assuming that k+m<N, i.e., if there are more than m steps away from the end of the horizon. In this method, called m-step truncated rollout, processing maximizes over y the m-step Q-factor of the greedy policy π̅ according to Equation 9 set forth below, as follows:

$$p ( y \vert {x}_{k} ) {P}_{k + 1 , m} ( y , \overline{π} ) ,$$

where the term:

$${P}_{k + 1 , m} ( y , \overline{π} ) = p ( {y}_{k + 2 , k + 1} ( y , \overline{π} ) \vert y ) \cdot {\prod }_{i = k + 2}^{k + m} p ( {y}_{i + 1 , k + 1} ( y , \overline{π} ) \vert {y}_{i , k + 1} ( y , \overline{π} ) )$$

is the m-step product of probabilities along the path generated by the greedy policy ft starting from y at time k+1, with each probability corresponding to a transition probability 720, refer also to Equation 11.

By contrast, in rollout without truncation, maximize over y, such as state 1 710, state 2 715, or state 3 725, for the term: p(y|xₖ)Pₖ₊₁(y, π̅), where the term:

$${P}_{k + 1} ( y , \overline{π} ) = p ( {y}_{k + 2 , k + 1} ( y , \overline{π} ) \vert y ) \cdot {\prod }_{i = k + 2}^{N - 1} p ( {y}_{i + 1 , k + 1} ( y , \overline{π} ) \vert {y}_{i , k + 1} ( y , \overline{π} ) ) ,$$

is the (N−k−1)-step product of probabilities along the path generated by the greedy policy starting from y at time k+1; with each probability corresponding to a transition probability 720. Refer also to Equations 1 and 6.

Multiple Policy Iterations-Double Rollout-Complexity Analysis: Another possibility is to apply the rollout approach successively, in multiple policy iterations, by using the rollout policy obtained at each iteration as the base policy for the next iteration. This corresponds to the fundamental dynamic programming algorithm of policy iteration. Performing on-line just two policy iterations amounts to using the rollout algorithm as a base policy for another rollout algorithm, referred to as a double rollout.

Generally, one-step look-ahead rollout uses O(q·N) applications of the base policy where q is the number of Q-factors calculated at each time step. For a more accurate estimate of the complexity of the greedy, rollout, and double rollout algorithms use the basic operation of the greedy operation which is the maximization over the q numbers p(y|xₖ), where y may be state 1 710, state 2 715, or state 3 725, and xₖ is the current state.

Thus m steps of the greedy algorithm, as in an m-step Q-factor calculation, costs q·m comparisons. In m-step truncated rollout, compare q greedy Q-factors so the number of comparisons per rollout time step is q²m+q. Over N time steps the total is (q²m+q)·N comparisons, while for the greedy algorithm starting from the initial state x₀ (e.g., state 1 710), the corresponding number is q. N. Thus, there is an amplification factor of qm+1 for the computation of simplified m-step truncated rollout over the greedy policy. Similarly, it can be estimated that there is an amplification factor of no more than qm+1 for using double rollout with (single) rollout as a base policy.

Thus, with each new policy iteration, there is an amplification factor 0(q·N) of the computational requirements. Still, however, the multiple iteration approach may be viable, even on-line, when combined with some of the other time-saving computational devices described above (e.g., truncation and simplification to reduce q), in view of the relative simplicity of the calculations involved and their suitability for parallel computation. This is particularly so for double rollout.

As an example, policy iteration has been applied successfully to the game of solitaire. The preceding variants of the rollout selection policy are formalized and compared to the greedy and most likely selection policies, both analytically and experimentally, in the discussion that follows. It is shown analytically that the rollout selection policy with one-step look-ahead has a performance improvement property, specifically, it generates more likely state sequences than the greedy policy, starting from any state such as state 1 710, state 2 715, or state 3 725.

In practice, the improvement is often very substantial, owing to the connection of the method with Newton's method. This has been verified in computational experiments and is consistent with over 30 years of accumulated computational experience with rollout algorithms.

### Performance Improvement Properties of Rollout Policies:

It is shown by induction a performance improvement property of the rollout algorithm with one-step look-ahead, namely that for all states x∈X and k, according to Equation 10 set forth below, as follows:

$${P}_{k} ( x , \overline{π} ) \leq {P}_{k} ( x , \tilde{π} ) ,$$

i.e., the probability of the sequence generated by the rollout policy \tilde{π} is greater than or equal to the probability of the sequence generated by the greedy policy \tilde{π}. This holds for any starting state x at any time k, such as state 1 710, state 2 715, or state 3 725.

For k=N this relation holds, since according to the term:

$${P}_{N} ( x , \overline{π} ) = {P}_{N} ( x , \tilde{π} ) ≡ 1 .$$

Assuming that the term:

$${P}_{k + 1} ( x , \overline{π} ) \leq {P}_{k + 1} ( x , \tilde{π} ) ,$$

for all x, is shown that the term:

$${P}_{k} ( x , \overline{π} ) \leq {P}_{k} ( x , \tilde{π} ) ,$$

for all x. Indeed, the preceding relations are used to write the Equations 11, 12, 13, and 14, set forth below, as follows:

$${P}_{k} ( x , \tilde{π} ) = p ( {\tilde{μ}}_{k} ( x ) \vert x ) {P}_{k + 1} ( {\tilde{μ}}_{k} ( x ) , \tilde{π} ) as Equation 11 ;$$

$$\geq p ( {\tilde{μ}}_{k} ( x ) \vert x ) {P}_{k + 1} ( {\tilde{μ}}_{k} ( x ) , \overline{π} ) as Equation 12 ;$$

$$\geq p ( {\overline{μ}}_{k} ( x ) \vert x ) {P}_{k + 1} ( {\overline{μ}}_{k} ( x ) , \overline{π} ) as Equation 13 ; and$$

$$= {P}_{k} ( x , \overline{π} ) as Equation 14.$$

where the first equality follows from the definition of the probabilities corresponding to the rollout policy \tilde{π};
where the first inequality follows from the induction hypothesis;
where the second inequality follows from the fact that the rollout choice \tilde{μ}ₖ(x) maximizes the Q-factor p(y|x)Pk+1(y, π) over y; and
where the second equality follows from the definition of the probabilities corresponding to the greedy policy T.

Thus, the induction proof of the improvement property is complete. The performance improvement property continues to hold for double rollout and for successive multiple iterations of the rollout policy, and in fact it can be shown that after a sufficiently large number of iterations it yields the most likely selection policy. This is a consequence of classical results, which establish the finite convergence to an optimal policy of the policy iteration algorithm for finite-state Markovian decision problems. Performance improvement can also be established for the E-step look-ahead version of the rollout policy, using an induction proof that is similar to the one given above for the one-step look-ahead case. Moreover, conditions exist under which simplified rollout maintains the performance improvement property.

However, it is not necessarily true that the performance of the E-step look-ahead rollout policy improves as (increases; see the computational results of the next section. Similarly, it is not necessarily true that the m-step truncated rollout policy performs better than the greedy policy. It performs better than an m-step version of the greedy policy, which generates a sequence of m+1 states, starting from the current state and using the greedy policy. On the other hand, known performance deterioration examples of this type are artificial and are apparently rare in practice.

### Computational Comparison of Greedy, Optimal, and Rollout Policies:

Computational studies of the proposed rollout approaches are described in two contexts. First, consider small-scale Markov chains and N=100 steps, where computing the optimal policy via the DP-like algorithm discussed in Section 2 is feasible. One goal is to demonstrate that the rollout algorithm and its variants produce N-step sequences whose probability of occurrence is close to the optimal. In contrast, the ones selected by the greedy policy are much less likely. Then consider the Markov chain defined by a fine-tuned GPT, modified from the open-source implementation given by Karpathy. Due to the large size of state space, computing a most likely sequence from a given initial state is an intractable problem. It is shown that the described rollout approaches are effective for this problem despite its scale, and that substantial improvements over the greedy policy are obtained.

Small-Scale Markov Chains: The results of experiments are described with small-scale Markov chains. The size of these chains is small enough so that the DP-algorithm (or a Viterbi algorithm) can be used to compute the most likely sequence starting from every initial state. Thus, the performance differences between the rollout, greedy, and optimal policies can be accurately assessed.

Techniques are described for generating the Markov chains so that they resemble those defined by a GPT, and metrics are provided according to which the performance of rollout is evaluated. Consider problems involving 100 states, and demonstrate that the performance improvement of rollout with one-step and multistep look-ahead over the greedy policy is substantial, consistent with earlier experience with rollout algorithms and the Newton step conceptualization that underlies such techniques. Similarly, it is found that truncated rollout algorithms perform nearly as well as their untruncated counterparts, while consuming much less computation.

Experiments illustrate some typical patterns in occurrence probabilities of sequences computed via optimal, rollout, and greedy policies. Performance of untruncated and truncated double rollouts are presented with one-step and multistep look-ahead, noting that the truncated versions remain effective. In addition, it was found that the performance improvement of double rollout over (single) rollout is substantial, even when the number of look-ahead steps is small.

Consider the process through which the Markov chains have been generated. Assume that there is a fixed number q of states y such that p(y|x)>0, with q being the same for all states x. In the context of an n-gram, where the state space X is the set of all n-word sequences, q is the vocabulary size, while the state space size, denoted by |X|, is the cardinality of X; both of these numbers can be enormous.

Refer to the ratio q/|X| (in percent) as the branching factor of the Markov chain. For each state x E X, generate, according to a uniform distribution, a set of q distinct states y such that p(y|x)>0. The probabilities p(y|x) are also generated according to a uniform distribution.

Given a Markov chain with state space X and fixed branching factor as described above, consider the most likely sequence selection problem with sequence length N, starting from every initial state. Compute the most likely sequence via the DP-like algorithm described above and the sequence given by the greedy policy. They are used to evaluate the performance of rollout approaches. Because the probability of an entire sequence is typically very small, it may be represented as the average of its constituent transition probabilities (i.e., a geometric mean over N as will be described below).

In particular, given a sample set C of Markov chains, compute the optimal occurrence probability of generated sequences, averaged over all chains, states, and transitions, and denoted by

$${( {P}_{0}^{*} )}^{1 / N} ,$$

according to the average geometric mean formula, as follows:

$${( {P}_{0}^{*} )}^{\frac{1}{N}} = \frac{{\sum }_{c ∈ C} {\sum }_{x ∈ X} {( {P}_{0 , c}^{*} ( x ) )}^{\frac{1}{N}}}{\vert C \vert \cdot \vert X \vert} ,$$

where

$${P}_{0 , c}^{*} ( x )$$

is the optimal occurrence probability with x₀=x and Markov chain c in the sample set. Similarly, compute the occurrence probabilities of sequences generated by the greedy policy averaged over all chains, states, and transitions, and denoted by (P̅₀)^{1/N}, according to Equation 15 set forth below, as follows:

$${( {\overline{P}}_{0} )}^{1 / N} = \frac{{\sum }_{c ∈ C} {\sum }_{x ∈ X} {( {P}_{0 , c} ( x , \overline{π} ) )}^{1 / N}}{\vert C \vert \cdot \vert X \vert} .$$

Here P_{0,c}(x, π̅) is the transition probability of the sequence generated by the greedy policy with x₀=x and Markov chain indexed by c. For the rollout algorithm (or variants thereof), processing computes its averaged occurrence probability (\tilde{P}₀)^{1/N} similar to Equation 15, with \tilde{π} in place of π̅. Then the performance of this rollout approach is measured by its percentage recovery of optimality loss of the greedy policy, given by Equation 16 set forth below, as follows:

$$\frac{{( {\tilde{P}}_{0} )}^{1 / N} - {( {\overline{P}}_{0} )}^{1 / N}}{{( {P}_{0}^{*} )}^{1 / N} - {( {\overline{P}}_{0} )}^{1 / N}} \times 100 ( \% ) .$$

Beyond the quantitative measure, the broader significance of rollout methods lies in their applicability to reinforcement learning frameworks, as discussed below.

Integration with Reinforcement Learning: Rollout policies can be directly applied within reinforcement learning frameworks as a mechanism for policy improvement. In particular, when a baseline policy is available but may be suboptimal, rollout with one-step or multi-step lookahead provides an implementable procedure for obtaining improved actions without requiring a full solution of the underlying Markov decision process. This aligns with standard reinforcement learning techniques where approximate models or sample trajectories are used in place of exact transition probabilities, thereby enabling rollout to be employed even when the full system dynamics are not explicitly known. In such contexts, rollout can be interpreted as a practical policy iteration method that bridges dynamic programming with sample-based approaches, and can be further extended to actor-critic methods or Monte Carlo tree search for large-scale problems.

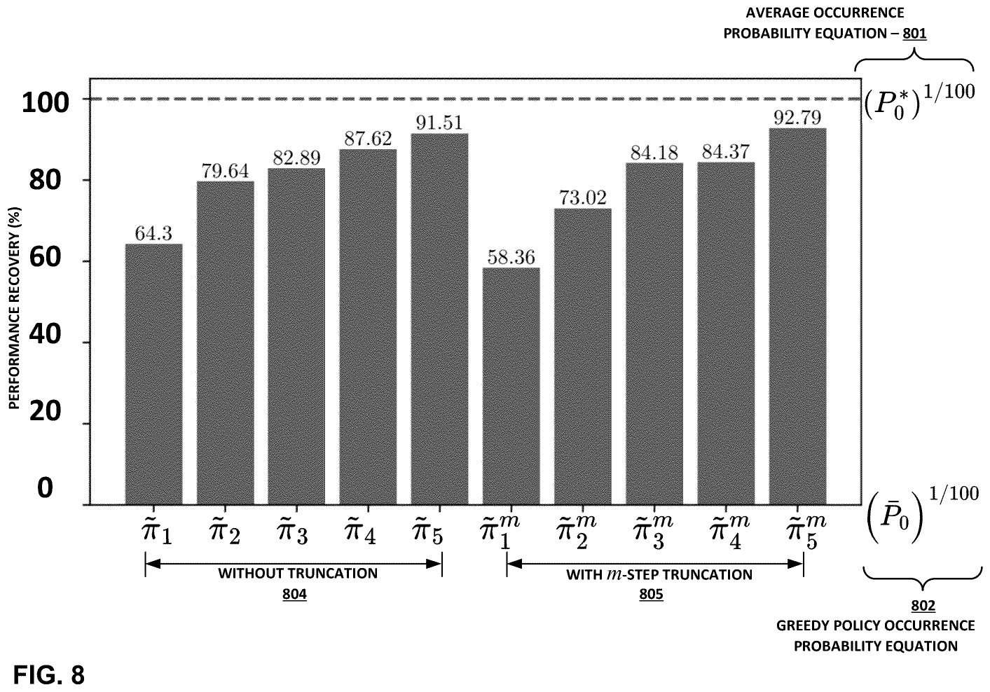

FIG. 8 illustrates percentage recovery of the optimality loss equation 803 of the greedy policy through the use of rollout and its variants, in accordance with aspects of the disclosure. For instance, rollout and its variants may be applied to sequence selection problems with N=100 for 50 randomly generated Markov chains with 100 states and 5% branching factor.

Here [symbol] represents rollout with [symbol] -step look-ahead, and

$${\tilde{π}}_{ℓ}^{m}$$

represents m-step truncated rollout for m=10 with [symbol] -step look-ahead. It can be seen that on average, rollout and its variants provide a substantial improvement over the greedy policy occurrence probability equation 802, that the improvement increases with the size of the look-ahead, and that truncated rollout methods perform comparably to their exact counterparts.

### Experimental Results:

Variance Reduction and Probabilistic Guarantees: In addition to the average recovery percentages noted above, rollout methods exhibit reduced variance in their performance estimates by virtue of averaging over multiple simulated trajectories. This variance reduction effect provides more stable estimates of occurrence probabilities compared to single-trajectory greedy policies. In practice, repeated sampling yields concentration of the estimated recovery rates, which in turn furnishes probabilistic guarantees on the degree of improvement achieved relative to the greedy baseline. Thus, rollout policies not only improve mean recovery but also ensure tighter confidence intervals around the expected performance.

Experimental results show that the percentage recovery of the optimality loss equation 803, computed as

$$\frac{{( {\tilde{P}}_{0} )}^{1 / 100} - {( {\overline{P}}_{0} )}^{1 / 100}}{{( {P}_{0}^{*} )}^{1 / 100} - {( {\overline{P}}_{0} )}^{1 / 100}} \times 100 ( \% )$$

has ranged roughly from 60% to 90% for one-step to five-step look-ahead, untruncated and truncated rollout with m=10 steps up to truncation. The performance improves as the length of the look-ahead increases, but seems remarkably unaffected by the 90% truncation of the rollout horizon. The relative insensitivity of the performance of truncated rollout to the number of rollout steps m has been observed in other application contexts as well. The figure has been generated with a sample of 50 different Markov chains with |X|=100 states, branching factor equal 5%, and sequence length N=100.

Practical Significance and Robustness: The insensitivity of performance to truncation depth highlights that rollout methods retain most of their effectiveness even under resource-limited conditions where long horizons are infeasible. This robustness makes rollout practical for large-scale or real-time applications, since comparable recovery rates can be achieved without incurring the exponential cost of deep lookahead. Moreover, the observed stability across multiple randomly generated Markov chains underscores the generality of the approach, ensuring that the improvements are not restricted to specific problem instances but apply broadly across domains.

Experiments tested rollout with one-step and multistep look-ahead (ranging from 2 to 5 steps) in the without truncation region 804, and their m-step truncated counterparts with m=10 in the with m-step truncation region 805. Their percentage recovery, evaluated according to the average occurrence probability equation 801, expressed as

$${( {P}_{0}^{*} )}^{1 / 100} ,$$

is given in FIG. 8 for the without truncation region 804 and the with m-step truncation region 805, where [symbol] denotes rollout with [symbol] -step look-ahead, and

$${\tilde{π}}_{ℓ}^{m}$$

denotes m-step truncated rollout with [symbol] -step look-ahead.

It can be seen that the sequences produced by rollout improve substantially over those generated by the greedy policy occurrence probability equation 802, expressed as (P̅₀)^{1/100}. In fact, the sequences generated by the untruncated rollout policy \tilde{π} all have larger occurrence probabilities than those generated by the greedy policy occurrence probability equation 802, consistent with the analysis described above in the context of the section entitled “Performance Improvement Properties of Rollout Policies.” In addition, on average, the performance improves as the size of the look-ahead increases. This is not true for rare individual examples, and there is only a small degradation of performance when applying the truncated rollout compared with untruncated rollout for all look-ahead sizes considered. This is significant as truncated rollout greatly reduces the computation of ft. Refer to the complexity analysis described in the context of the section entitled “Variants of the Rollout Policy.”

Summary of Experimental Findings: Overall, the experimental results consistently demonstrate that rollout methods yield substantial improvements over the greedy policy baseline. These improvements manifest both in higher mean recovery percentages and in reduced variance of estimates, thereby offering stronger probabilistic guarantees of performance. Moreover, the effectiveness of rollout remains robust even under truncated horizons, with performance largely preserved while significantly reducing computational cost. Taken together, these findings confirm the theoretical analysis: rollout and its variants provide a practical and reliable means of improving policy quality across a broad range of problem settings.

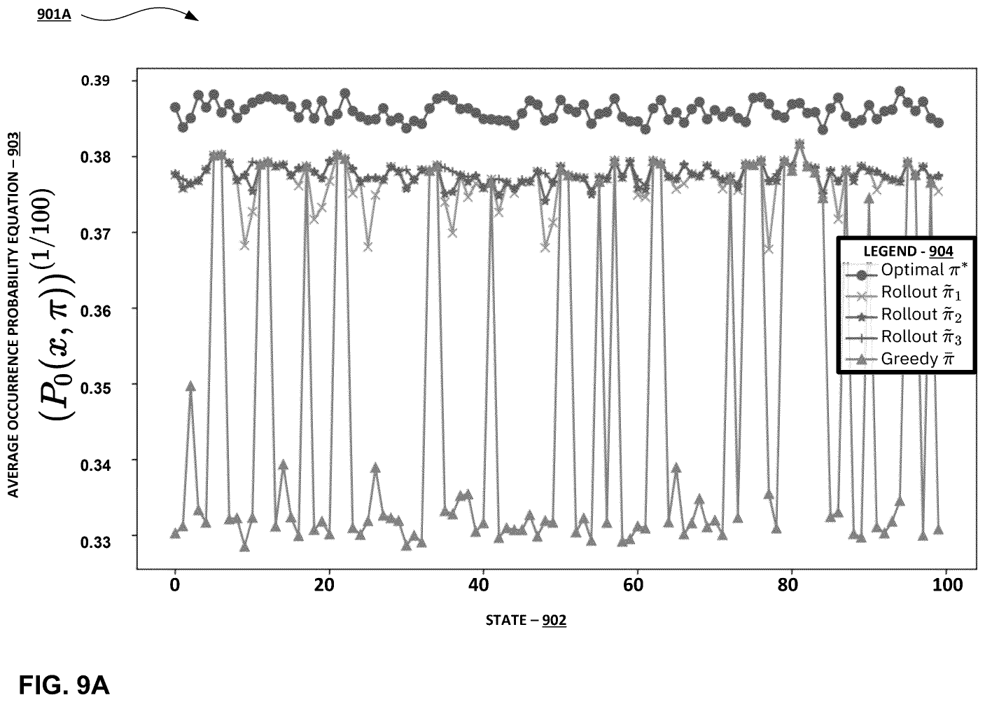

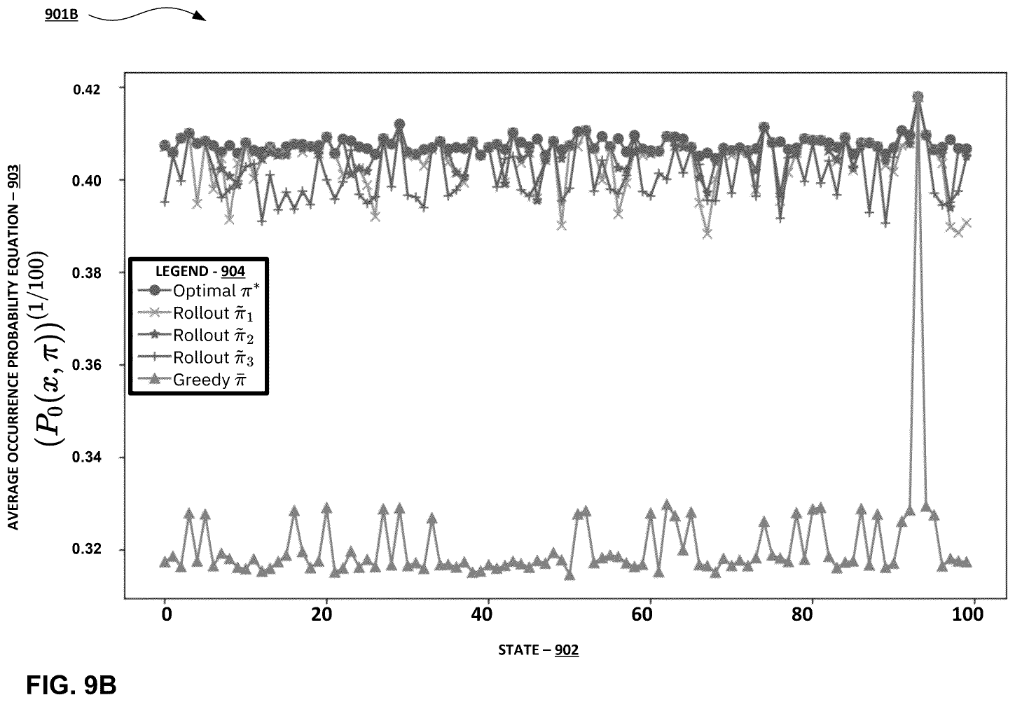

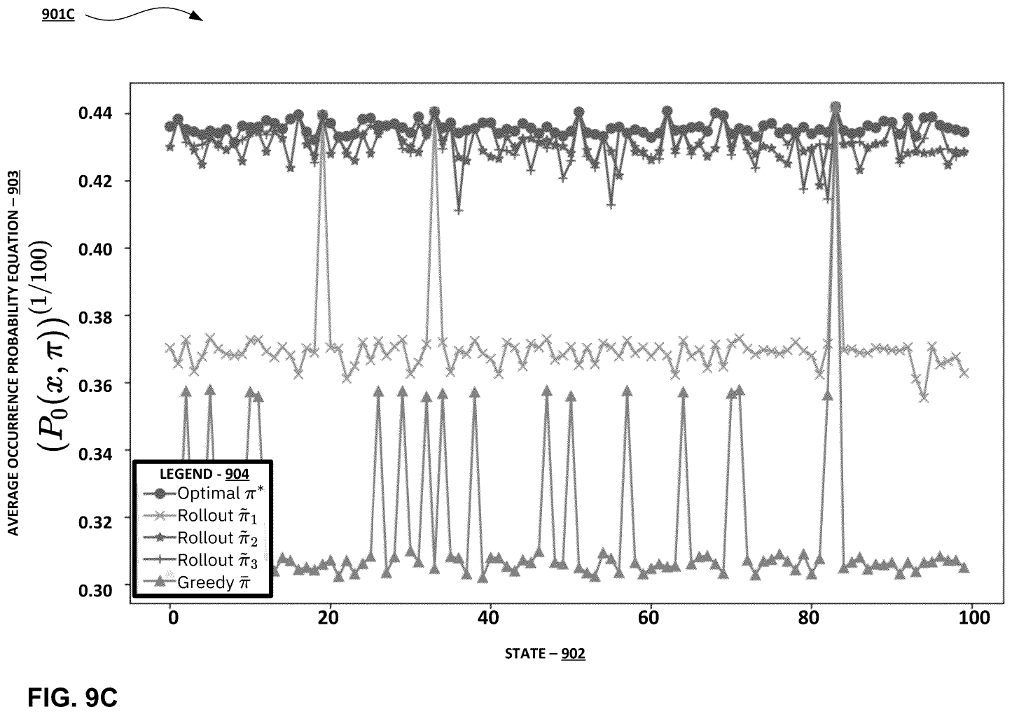

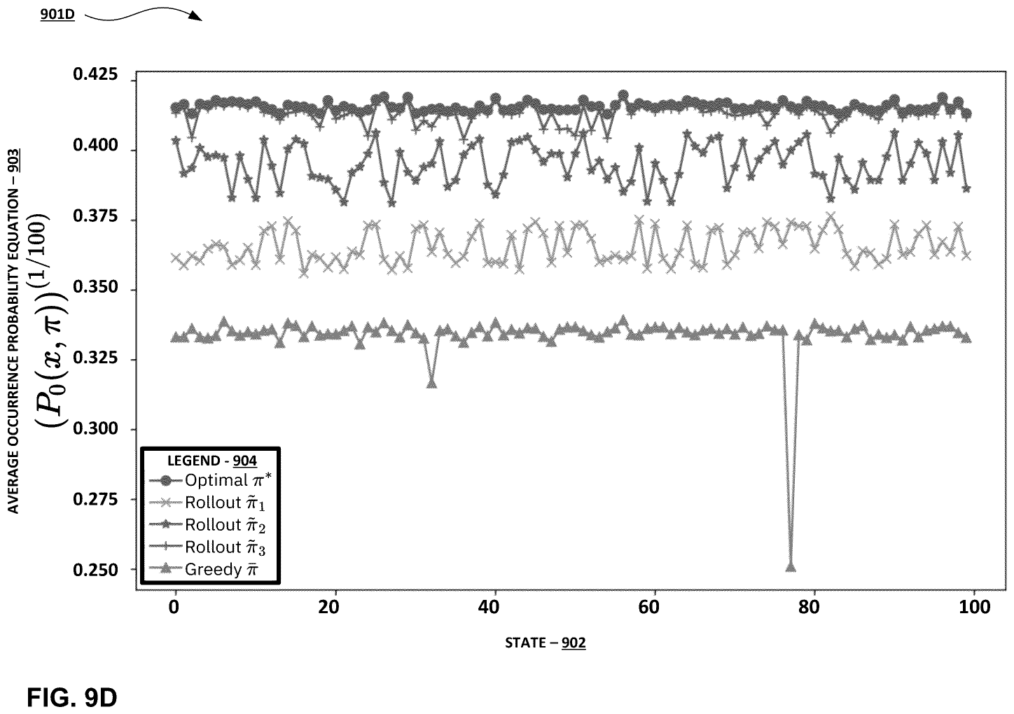

FIGS. 9A-9D collectively illustrate nuanced behaviors of rollout under varying look-ahead depths and problem conditions. These examples highlight both the strengths and potential limitations of the approach, showing cases where additional look-ahead yields diminishing returns, cases where improvements are substantial, and scenarios where performance differences emerge across state distributions.

FIG. 9A depicts plot 901A illustrating a problem where increasing the look-ahead length from one step to three steps does not result in significant improvement over rollout π₁, in accordance with aspects of the disclosure.

FIG. 9B depicts plot 901B illustrating a problem where rollout π₁ produces sequences with high average occurrence probability equation 903 values across states 902, such that additional look-ahead beyond one step yields little improvement; in this case, rollout 13 even reduces performance for many states 902, in accordance with aspects of the disclosure.

FIG. 9C depicts plot 901C illustrating a problem where substantial improvement in the average occurrence probability equation 903 occurs with rollout mu and further improvement occurs with rollout 12, with smaller incremental changes for rollout π₃, in accordance with aspects of the disclosure.

FIG. 9D depicts plot 901D illustrating a problem in which increasing the look-ahead length from one step to three steps leads to steady and gradual improvement across states 902, in accordance with aspects of the disclosure.

For each state 902, the value of the average occurrence probability equation 903 is given by probabilities (P₀(x, π))^{(1/100)}, for each state x∈X, where π can be π*, [symbol] the with [symbol] =1,2,3, for rollout π₁, rollout π₂, rollout π₃, or greedy π̅, as indicated in legend 904.

Additional results are provided for double rollout, which applies the rollout method described in Section 3 with its base policy given by rollout π₁, as indicated in legend 904. In this configuration, double rollout is equivalent to two successive policy iterations. Double rollout is applied in real time and computed only for states 902 that are needed, unlike conventional policy iteration that operates offline for all states 902. Other rollout variants, such as truncated and/or multistep look-ahead rollout, can also be used as base policies.

Each of FIGS. 9A, 9B, 9C, and 9D illustrate the results corresponding to a single representative Markov chain. However, different probability patterns do not appear in equal proportions in numerical experiments. In particular, the pattern that appears in FIG. 9A is relatively rare. Generally, the common feature shared by all the results in FIGS. 9A, 9B, 9C, and 9D is that rollout and its variants result in substantial improvement over the greedy policy across all states. Moreover, longer look-ahead leads to more likely sequences for the great majority of initial states. However, there are some notable differences in the patterns shown in FIGS. 9A, 9B, 9C, and 9D. For instance, in FIG. 9B, a longer look-ahead (up to 3), does not produce significant improvement over a one-step look-ahead. Similarly, with reference again to FIG. 9B, sequences selected by rollout with one-step look-ahead are already near optimal. A relatively rare phenomenon shown in FIG. 9B is that the longer look-ahead with [symbol] =3 deteriorates the performance of rollout for many states. Each of FIG. 9C and FIG. 9D represents fairly common patterns, in which a longer look-ahead results in substantial improvement.

This double rollout method can be viewed as two successive policy iterations, as discussed above. Note that double rollout is applied in real-time and computes only for states that are needed, in contrast with conventional applications of policy iteration, which operate off-line and for all states. Note also that other rollout variants can be used as base policies, such as truncated and/or multistep look-ahead rollout.

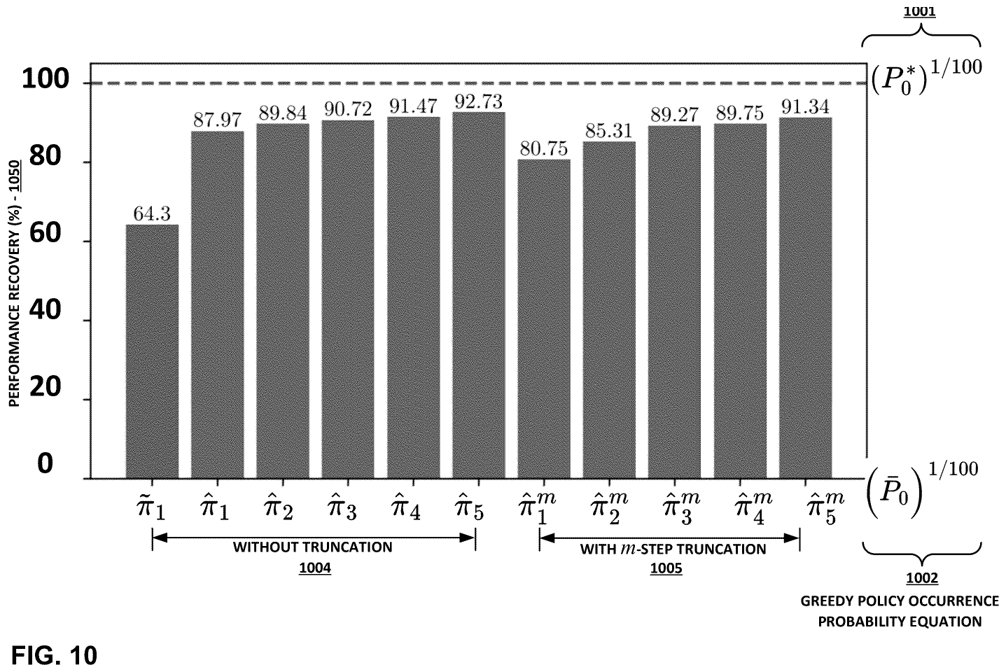

FIG. 10 illustrates performance recovery for various rollout-based policies, in accordance with aspects of the disclosure. Performance recovery is measured as a percentage of the optimality loss of greedy policy occurrence probability equation 1002 recovered through the use of double rollout and its variants, as indicated by the vertical axis labeled performance recovery (%) 1050. The experiments depicted in FIG. 10 were conducted for sequence selection problems with N=100, 50 randomly generated Markov chains with 100 states, and a 5% branching factor.

Complexity Analysis of Rollout Variants: The computational efficiency of rollout depends critically on the depth of look-ahead and whether truncation is applied. In a full, untruncated rollout, the policy evaluation step requires computing expected returns across all reachable states, which scales exponentially with the look-ahead horizon. This becomes infeasible in large state spaces or when real-time decisions are required. Truncated rollout addresses this by limiting the expansion to a fixed horizon, thereby reducing the number of successor states that must be evaluated at each step. As a result, truncated rollout scales linearly with the number of states considered under the truncated horizon, rather than with the full state space.

Multistep look-ahead further increases computational demands, but the cost remains substantially less than conventional policy iteration because rollout only evaluates successor states encountered under the current trajectory, instead of performing a full sweep across all states. This “trajectory-focused” computation provides a practical balance between performance gains and tractable computation.

In practice, the complexity of truncated rollout grows as O(N·H), where N is the number of states visited during a trajectory and H is the truncated look-ahead depth. By contrast, conventional dynamic programming-based policy iteration requires evaluating the expected returns over all possible state-action pairs at each update, regardless of whether those states are actually encountered in execution. Consequently, truncated rollout is particularly well-suited for online and large-scale applications, where computational resources and latency constraints are critical factors.

The foregoing complexity analysis demonstrates that rollout variants, including truncated and multistep methods, provide a systematic mechanism for trading off performance against computational cost. This enables efficient deployment of rollout-based policies in real-time control, large Markov decision processes, and other domains where exhaustive policy evaluation is impractical.

Average occurrence probability equation 1001 is shown at the top of the figure as the reference performance target corresponding to

$${( {P}_{0}^{*} )}^{1 / 100} .$$

Greedy policy occurrence probability equation 1002, (P̅₀)^{1/100}, is shown at the bottom right. Without truncation 1004 includes term \tilde{π}₁, representing single rollout with one-step look-ahead, and \hat{π}₁ through \hat{π}₅, representing double rollout with [symbol] -step look-ahead for [symbol] =1, 2, 3, 4, and 5. With m-step truncation 1005 includes

$${\hat{π}}_{ℓ}^{m}$$

through

$${\hat{π}}_{5}^{m} ,$$

representing m-step truncated double rollout with m=10 and [symbol] -step look-ahead for [symbol] =1, 2, 3, 4, and 5.

The leftmost bar, \tilde{m}₁, corresponds to single rollout with one-step look-ahead, achieving a performance recovery of 64.3%. The next five bars, \hat{π}₁ through \hat{π}₅, correspond to double rollout without truncation 1004, with performance recovery increasing from 87.97% for [symbol] =1 to 92.73% for [symbol] =5. The right-hand group of bars,

$${\hat{π}}_{ℓ}^{m}$$

through

$${\hat{π}}_{5}^{m} ,$$

corresponded to double rollout with m-step truncation 1005 (m=10), achieving recovery values from 80.75% to 91.34%. These results indicate that both untruncated and truncated double rollout significantly outperform greedy policy occurrence probability equation 1002 and single rollout \tilde{π}₁.

The truncated versions of double rollout maintain strong performance while providing substantial computational savings, simulating only m/N=5% of the remaining sequence at each state. Additional experiments were conducted with problems involving 1000 states, a 1% branching factor, and sequence length N=1000, producing qualitatively similar performance improvements.

In a separate computational study, methods were applied to text generation with a generative pretrained transformer (GPT) programmed by Karpathy and fine-tuned. In this context, computing the most likely sequence via a dynamic programming-like algorithm is intractable due to large vocabulary size and sequence length. A simplified rollout with one-step look-ahead and its m-step truncated counterpart was therefore employed. Graphical processing units (GPUs) computed the Q-factors of the rollout schemes in parallel at each state. For the GPT, the values of n and q were 1024 and 50258, respectively, with sequence length N=200. The GPT, fine-tuned on fictional works of James A. Michener, was prompted via GPT-4 to generate twenty opening sentences in Michener's style, padded to form initial states. For each initial state, both greedy policy occurrence probability equation 1002 and the simplified rollout policy were applied. At each step, the simplified rollout policy computed Q-factors for the top ten most likely next words. The m-step truncated rollout was implemented with m=10, corresponding to simulating only 5% of the remaining sequence length.

After training or fine-tuning, a GPT's output probabilities may be further modified through additional parameters (e.g., repetition penalties) that define a well-specified Markov chain. For this Markov chain, the size of the state space is qⁿ, where q is the vocabulary size, making exact computation of the most likely sequence intractable. Since both q and n are large in modern language models, computing the most likely sequence from a given initial word string is an intractable problem, even for a small sequence length. The GPT used in computational studies involves 124 million weights using customary default initial values of the weights.

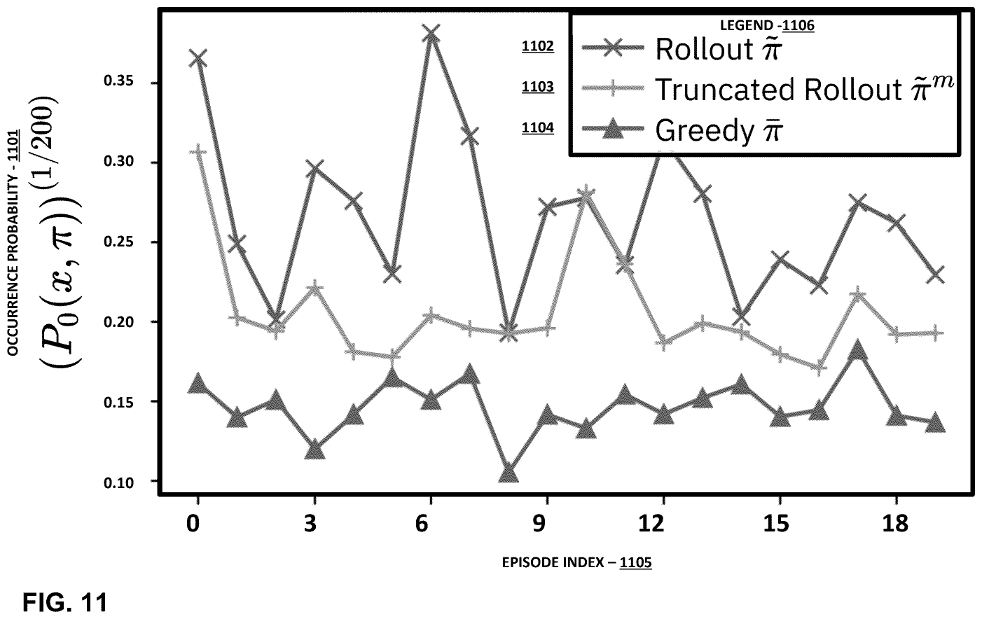

The sequence occurrence probabilities from these GPT experiments, for both truncated and untruncated simplified rollout policies as well as the greedy policy, are shown in FIG. 11 for 20 different initial states.

FIG. 11 depicts occurrence probability 1101 of sequences generated by greedy π̅ 1104, truncated rollout \tilde{π}^{m} 1103, and rollout \tilde{π} 1102, as shown in legend 1106, in accordance with aspects of the disclosure. Episode index 1105 corresponds to the horizontal axis positions of the plotted data. At each step, rollout \tilde{π} 1102 computes ten Q-factors corresponding to the ten most likely next words, and truncated rollout \tilde{π}^{m} 1103 simulates five percent of the remaining sequence.

With this GPT, values of n and q are 1024 and 50258, respectively, and the aim is to compute word sequences with length N=200. GPT was fine-tuned with a dataset composed of the fictional writings of James A. Michener. Experiments generated twenty different initial states x₀ using GPT4 with the prompt “Provide twenty opening sentences for James A. Michener style fiction.” The GPT4 responses were padded with placeholder words to the proper length to form initial states. For each initial state x₀, greedy \tilde{π} 1104 and rollout \tilde{π} 1102 were applied for sequence selection. At each step, rollout \tilde{π} 1102 computed ten Q-factors, each corresponding to the ten most likely next words. Truncated rollout \tilde{π}^{m} 1103 was implemented with m=10, so that it simulated m/N=5% of the remaining sequence.

As seen in FIG. 11, substantial performance improvements are obtained by rollout \tilde{π} 1102 and truncated rollout \tilde{π}^{m} 1103 over greedy \tilde{π} 1104 in all twenty test cases. This is consistent with earlier analysis in the section entitled “Performance Improvement Properties of Rollout Policies” and with small-scale Markov chain results.

In such a way, algorithms are provided for finding highly likely sequences in Markov chains and their applications in n-grams, transformers, and HMMs. These algorithms, based on the rollout approach starting from a base policy such as greedy \tilde{π} 1104, often yield substantial performance gains at modest computational cost. They can also be adapted for constrained sequence problems or for Markov chains with termination states. In the transformer context, it remains an open question whether higher sequence likelihood directly translates to qualitative improvements in output, as objective quality metrics may be absent.

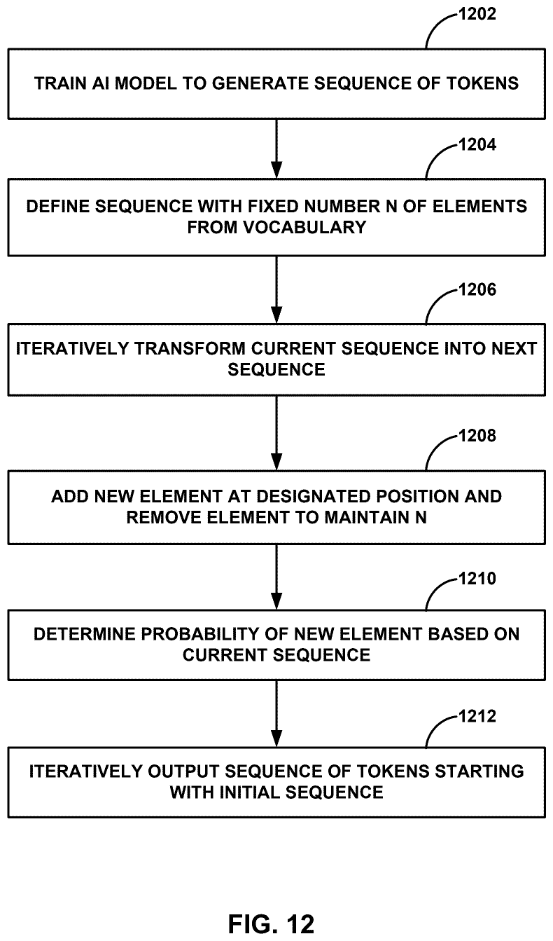

FIG. 12 is a flow diagram illustrating an example method for training and operating an artificial intelligence (AI) model to generate and iteratively transform sequences of tokens, in accordance with aspects of this disclosure. FIG. 12 is described with respect to computing device 100, examples of processing circuitry, and systems configured to generate and process sequences of tokens as discussed in relation to FIGS. 1-11. However, the techniques of FIG. 12 may be performed by different components of computing device 100 or by additional or alternative systems.

Processing circuitry of computing device 100 may be configured to train an AI model to generate a sequence of tokens (1202). For example, the processing circuitry may be configured to train an AI model to generate a sequence of tokens starting from an initial sequence.

Processing circuitry of computing device 100 may be configured to define sequence with fixed number n of elements from vocabulary (1204). For example, the processing circuitry may be configured such that each sequence in the sequence of tokens comprises a fixed number n of elements selected from a vocabulary list accessible to the AI model.

Processing circuitry of computing device 100 may be configured to iteratively transform current sequence into next sequence (1206). For example, the processing circuitry may be configured to iteratively transform a current sequence among the sequence of tokens into a next sequence.

Processing circuitry of computing device 100 may be configured to add a new element at designated position and remove element to maintain n (1208). For example, the processing circuitry may be configured to add a new element at a designated position and remove an element from another position in the sequence to maintain the fixed number n of elements.

Processing circuitry of computing device 100 may be configured to determine probability of new element based on current sequence (1210). For example, the processing circuitry may be configured to determine a probability of selecting the new element for the next sequence based on the current sequence, without dependence on sequences occurring before the current sequence.

Processing circuitry of computing device 100 may be configured to iteratively output a sequence of tokens starting with the initial sequence (1212). For example, the processing circuitry may be configured to iteratively output the sequence of tokens, starting with the initial sequence, using the iterative transformations of the current sequence to form the next sequence.

In this way, FIG. 12 illustrates an example process for training and operating an AI model to iteratively generate, transform, and output sequences of tokens. The disclosed techniques enable sequence generation based on local sequence context without reliance on preceding sequences, facilitating efficient and flexible modeling of token-based data for applications in artificial intelligence and machine learning.

This disclosure includes the following examples.

Example 1—A method comprising: training an artificial intelligence (AI) model to generate a sequence of tokens, starting from an initial sequence; wherein each sequence in the sequence of tokens comprises a fixed number n of elements selected from a vocabulary list accessible to the AI model; iteratively transforming a current sequence among the sequence of tokens into a next sequence by adding a new element at a designated position and removing an element from another position to maintain the fixed number n of elements; wherein a probability of selecting the new element for the next sequence is determined based on the current sequence without dependence on sequences occurring before the current sequence; and iteratively outputting the sequence of tokens, starting with the initial sequence, using the iterative transformations of the current sequence to form the next sequence.

Example 2—The method of example 1, wherein the iteratively transforming comprises: removing exactly one element from the current sequence and inserting exactly one new element at a designated position; and forming the next sequence based only on the current sequence without dependence on any prior sequences.

Example 3—The method of example 1, wherein the probability of selecting the new element for forming the next sequence is derived from transition probabilities of a stationary Markov chain defined over the next sequences generated by the iterative transforming of the current sequence.

Example 4—The method of example 3, wherein the probability of selecting the new element for the next sequence is denoted p (x_(k+1)|x_k), where x_k denotes the current sequence and x_(k+1) denotes the next sequence, and the new element is selected according to a selection policy that maximizes that probability.

Example 5—The method of example 3, wherein the stationary Markov chain is defined over the elements of the vocabulary list, such that the transition probabilities correspond to transitions between elements of the vocabulary list used to form the next sequence.

Example 6—The method of example 1, wherein selecting the new element for the next sequence is performed according to one of: a greedy selection policy; a most likely sequence selection policy; or a modified greedy selection policy with a rollout using a one-step, two-step, or multi-step look-ahead heuristic, optionally implemented as a single policy iteration step in approximate dynamic programming to refine a heuristic selection policy.

Example 7—The method of example 1, wherein, in the iteratively transforming, the positions for adding and removing elements are either: fixed as the first and last positions in the sequence, respectively; or determined dynamically based on a scoring function applied to candidate positions.

Example 8—The method of example 1, wherein the artificial intelligence model is implemented using an n-gram model, a transformer model having a fixed-length context window, an attention-based model, or a combination thereof.

Example 9—The method of example 1, wherein the artificial intelligence model generates the sequence of tokens representing states in a Markov process or other probabilistic state machine corresponding to a non-linguistic process, including one of: a game-theoretic model, an economic model, a biological model, or another suitable probabilistic process.

Example 10—The method of example 1, wherein selecting the new element for the next sequence is performed using Viterbi decoding applied in a Hidden Markov Model operating on the current sequence.

Example 11—The method of example 1, wherein the generation of the sequence of tokens has a computational complexity that is polynomial in n and the vocabulary size of the artificial intelligence model.

Example 12—The method of example 1, wherein training the artificial intelligence model includes fine-tuning a pre-trained language model using a dataset of fixed-length token sequences.

Example 13—A system comprising: processing circuitry; non-transitory computer readable media; and instructions that, when executed by the processing circuitry, configure the processing circuitry to: train an artificial intelligence (AI) model to generate a sequence of tokens, starting from an initial sequence; wherein each sequence in the sequence of tokens comprises a fixed number n of elements selected from a vocabulary list accessible to the AI model; iteratively transform a current sequence among the sequence of tokens into a next sequence by adding a new element at a designated position and removing an element from another position to maintain the fixed number n of elements; wherein a probability of selecting the new element for the next sequence is determined based on the current sequence without dependence on sequences occurring before the current sequence; and iteratively output the sequence of tokens, starting with the initial sequence, using the iterative transformations of the current sequence to form the next sequence.

Example 14—The system of example 13, wherein the probability of selecting the new element for the next sequence is derived from transition probabilities of a stationary Markov chain defined over the next sequences generated by the iterative transforming of the current sequence.

Example 15—The system of example 13, wherein the new element for the next sequence is selected according to one of: a greedy selection policy; a most likely sequence selection policy; or a modified greedy selection policy with a rollout using a one-step, two-step, or multi-step look-ahead heuristic, optionally implemented as a single policy iteration step in approximate dynamic programming to refine a heuristic selection policy.

Example 16—The system of example 13, wherein, in the iteratively transforming, the positions for adding and removing elements are either: fixed as the first and last positions in the sequence, respectively; or determined dynamically based on a scoring function applied to candidate positions.

Example 17—The system of example 13, wherein the artificial intelligence model is implemented as an n-gram model, a transformer model having a fixed-length context window, an attention-based model, or a combination thereof.

Example 18—The system of example 13, wherein the artificial intelligence model generates the sequence of tokens representing states in a Markov process or another probabilistic state machine corresponding to a non-linguistic process, including at least one of: a game-theoretic model, an economic model, a biological model, or another suitable probabilistic process.

Example 19—The system of example 13, wherein selecting the new element for the next sequence is performed using Viterbi decoding applied in a Hidden Markov Model operating on the current sequence.

Example 20—Computer-readable storage media comprising instructions that, when executed, configure processing circuitry to: train an artificial intelligence (AI) model to generate a sequence of tokens, starting from an initial sequence; wherein each sequence in the sequence of tokens comprises a fixed number n of elements selected from a vocabulary list accessible to the AI model; iteratively transform a current sequence among the sequence of tokens into a next sequence by adding a new element at a designated position and removing an element from another position to maintain the fixed number n of elements; wherein a probability of selecting the new element for the next sequence is determined based on the current sequence without dependence on sequences occurring before the current sequence; and iteratively output the sequence of tokens, starting with the initial sequence, using the iterative transformations of the current sequence to form the next sequence.

Example 21—A computer program product comprising one or more instructions that, when executed by at least one processor, cause the at least one processor to perform any of the methods of examples 1-12.

Example 22—A device comprising means for performing any of the methods of examples 1-12.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
training an artificial intelligence (AI) model to generate a sequence of tokens, starting from an initial sequence;
wherein each sequence in the sequence of tokens comprises a fixed number n of elements selected from a vocabulary list accessible to the AI model;
iteratively transforming a current sequence among the sequence of tokens into a next sequence by adding a new element at a designated position and removing an element from another position to maintain the fixed number n of elements;
wherein a probability of selecting the new element for the next sequence is determined based on the current sequence without dependence on sequences occurring before the current sequence; and
iteratively outputting the sequence of tokens, starting with the initial sequence, using the iterative transformations of the current sequence to form the next sequence.

2. The method of claim 1, wherein the iteratively transforming comprises:
removing exactly one element from the current sequence and inserting exactly one new element at a designated position; and
forming the next sequence based only on the current sequence without dependence on any prior sequences.

3. The method of claim 1, wherein the probability of selecting the new element for forming the next sequence is derived from transition probabilities of a stationary Markov chain defined over the next sequences generated by the iterative transforming of the current sequence.

4. The method of claim 3, wherein the probability of selecting the new element for the next sequence is denoted p(xₖ₊₁|xₖ), where xₖ denotes the current sequence and xₖ₊₁ denotes the next sequence, and the new element is selected according to a selection policy that maximizes that probability.

5. The method of claim 3, wherein the stationary Markov chain is defined over the elements of the vocabulary list, such that the transition probabilities correspond to transitions between elements of the vocabulary list used to form the next sequence.

6. The method of claim 1, wherein selecting the new element for the next sequence is performed according to one of:
a greedy selection policy;
a most likely sequence selection policy; or
a modified greedy selection policy with a rollout using a one-step, two-step, or multi-step look-ahead heuristic, optionally implemented as a single policy iteration step in approximate dynamic programming to refine a heuristic selection policy.

7. The method of claim 1, wherein, in the iteratively transforming, the positions for adding and removing elements are either:
fixed as the first and last positions in the sequence, respectively; or
determined dynamically based on a scoring function applied to candidate positions.

8. The method of claim 1, wherein the artificial intelligence model is implemented using an n-gram model, a transformer model having a fixed-length context window, an attention-based model, or a combination thereof.

9. The method of claim 1, wherein the artificial intelligence model generates the sequence of tokens representing states in a Markov process or other probabilistic state machine corresponding to a non-linguistic process, including one of: a game-theoretic model, an economic model, a biological model, or another suitable probabilistic process.

10. The method of claim 1, wherein selecting the new element for the next sequence is performed using Viterbi decoding applied in a Hidden Markov Model operating on the current sequence.

11. The method of claim 1, wherein the generation of the sequence of tokens has a computational complexity that is polynomial in n and the vocabulary size of the artificial intelligence model.

12. The method of claim 1, wherein training the artificial intelligence model includes fine-tuning a pre-trained language model using a dataset of fixed-length token sequences.

13. A system comprising:
processing circuitry;
non-transitory computer readable media; and
instructions that, when executed by the processing circuitry, configure the processing circuitry to:
train an artificial intelligence (AI) model to generate a sequence of tokens, starting from an initial sequence;
wherein each sequence in the sequence of tokens comprises a fixed number n of elements selected from a vocabulary list accessible to the AI model;
iteratively transform a current sequence among the sequence of tokens into a next sequence by adding a new element at a designated position and removing an element from another position to maintain the fixed number n of elements;
wherein a probability of selecting the new element for the next sequence is determined based on the current sequence without dependence on sequences occurring before the current sequence; and
iteratively output the sequence of tokens, starting with the initial sequence, using the iterative transformations of the current sequence to form the next sequence.

14. The system of claim 13, wherein the probability of selecting the new element for the next sequence is derived from transition probabilities of a stationary Markov chain defined over the next sequences generated by the iterative transforming of the current sequence.

15. The system of claim 13, wherein the new element for the next sequence is selected according to one of:
a greedy selection policy;
a most likely sequence selection policy; or
a modified greedy selection policy with a rollout using a one-step, two-step, or multi-step look-ahead heuristic, optionally implemented as a single policy iteration step in approximate dynamic programming to refine a heuristic selection policy.

16. The system of claim 13, wherein, in the iteratively transforming, the positions for adding and removing elements are either:
fixed as the first and last positions in the sequence, respectively; or
determined dynamically based on a scoring function applied to candidate positions.

17. The system of claim 13, wherein the artificial intelligence model is implemented as an n-gram model, a transformer model having a fixed-length context window, an attention-based model, or a combination thereof.

18. The system of claim 13, wherein the artificial intelligence model generates the sequence of tokens representing states in a Markov process or another probabilistic state machine corresponding to a non-linguistic process, including at least one of: a game-theoretic model, an economic model, a biological model, or another suitable probabilistic process.

19. The system of claim 13, wherein selecting the new element for the next sequence is performed using Viterbi decoding applied in a Hidden Markov Model operating on the current sequence.

20. Computer-readable storage media comprising instructions that, when executed, configure processing circuitry to:
train an artificial intelligence (AI) model to generate a sequence of tokens, starting from an initial sequence;
wherein each sequence in the sequence of tokens comprises a fixed number n of elements selected from a vocabulary list accessible to the AI model;
iteratively transform a current sequence among the sequence of tokens into a next sequence by adding a new element at a designated position and removing an element from another position to maintain the fixed number n of elements;
wherein a probability of selecting the new element for the next sequence is determined based on the current sequence without dependence on sequences occurring before the current sequence; and
iteratively output the sequence of tokens, starting with the initial sequence, using the iterative transformations of the current sequence to form the next sequence.
